(19) United States
(12) Patent Application Publication
(10) Pub. No.: US 2017/0094023 A1
(43) Pub. Date: Mar. 30, 2017

(54) SMART PHOTO GALLERY APPLICATION FEATURING DYNAMIC PHOTO ORGANIZATION, PHOTO BACKUP, AND PRIVACY VAULT

(71) Applicant: PHOTOBUCKET CORPORATION, Denver, CO (US)

(72) Inventors: Cyrus Vimal JACK, Dublin, CA (US); Sheila Agoncillo ANDRES, Dublin, CA (US); Katharine A. HARE, Phoenix, AZ (US); Thomas A. MUNRO, Castle Rock, CO (US)

(21) Appl. No.: 15/283,034

(22) Filed: Sep. 30, 2016

Related U.S. Application Data
(60) Provisional application No. 62/235,422, filed on Sep. 30, 2015.

(51) Int. Cl. H04L 29/08; H04L 12/58; H04W 4/00

(52) U.S. Cl. CPC H04L 67/34; H04W 4/001; H04L 51/04; H04L 67/02; H04L 51/18

(57) ABSTRACT

Improved photo galleries featuring dynamic and automated photo organization, enhanced photo sharing, and photo backup with privacy features.

### CROSS-REFERENCE TO RELATED APPLICATIONS

The present application claims the benefit of U.S. Provisional Application No. 62/235,422, filed Sep. 30, 2015, the entire contents of which are incorporated herein by reference.

### BACKGROUND OF THE TECHNOLOGY

Seventy percent of photos are taken on mobile devices. However, the current software and systems for photo processing, management and organization are still designed based on desktop computers. A new system for mobile devices is necessary to streamline the photo processing, management, organization, and sharing on the go.

### SUMMARY OF THE TECHNOLOGY

More and more photos are taken on mobile devices (e.g., smartphones, tablets, etc.). Conventional methods for photo processing and management require a user to connect their mobile device to a desktop computer, so the user can transfer the photos from the mobile device to the desktop. Then, photo editing, management, backup, and organization are done on the desktop. However, accessing to a personal computer is not always feasible or convenient. Frequently, a mobile device runs out of storage, but a user still wants to take more photos. Therefore, there is a long-felt need for a new system for easily processing and managing photos on mobile devices.

In some scenarios, photos are compounded and multiple similar shots exist in the library, leading to a waste of storage. To address this issue, the technologies disclosed herein enable a deduplication system, which intelligently cleans up redundant photos.

In some scenarios, conventional photo grouping is limited to grouping by time or place. In contrast, the technologies disclosed herein enable automatically customized, curated playlists/albums and convenient sharing of playlists/albums on any device over mobile networks. Further, the system can perform screen casting or implementation on a smart TV.

In some scenarios, conventional photo backup transmits all photos to cloud storage. However, the technologies disclosed herein enable photo backup based on vault. A user can select and choose their desired photos to store to vault.

In some scenarios, conventional photo sharing does not offer a user-guided sharing mechanism. In contrast, the technologies disclosed herein enable a user to set up a sharing rule. Further, the system can automatically recognize sharing opportunities based recent sharing activities. Moreover, the technologies disclosed herein provide for a foto fade sharing mode, wherein photos are uploaded from a mobile device to a server, a URL is published, and access to the photos is provided for a limited time.

Further, the technology disclosed herein provides a cross-platform system for photo processing and management. Particularly, the system streamlines these tasks on mobile devices. Further, automated photo management performs intelligent analysis to deduplicate photos, so the storage on mobile devices can be released. Intelligent backup allows a user to backup photos without risk of losing photos.

In one aspect, disclosed herein are computing systems for photo processing and organization, the system comprising: (a) a digital processing device comprising a processor, a memory module and an operating system configured to perform executable instructions; (b) a touchscreen; and (c) a computer program including instructions executable by the digital processing device to create an application, the application comprising: (1) a software module receiving a plurality of photos; (2) a software module presenting the plurality of the photos to a user based on an intelligent analysis on the plurality of the photos; (3) a software module removing duplicated photos; (4) a software module grouping the plurality of the photos based on similarity; and (5) a software module processing the plurality of the photos based on a gesture. In some embodiments, the plurality of the photos is received from one or more imaging devices. In some embodiments, the plurality of the photos is received from another computing device. In some embodiments, the presenting the plurality of the photos is based on a user defined gallery layout. In some embodiments, the intelligent analysis comprises a statistical analysis. In some embodiments, the intelligent analysis comprises analyzing a history of viewing, editing and sharing the plurality of the photos. In some embodiments, the removing the duplicated photos comprises identifying similar or identical photos within a time windows. In further embodiments, the removing the duplicated photos comprises generating a representative photo from similar or identical photos and deleting the similar or identical photos. In still further embodiments, the representative photo comprises a photo selected from the similar or identical photos, or comprises a photo synthesized from the similar or identical photos. In some embodiments, the processing the plurality of the photos comprises one or more of: flipping one or more photos, deleting one or more photos, cropping one or more photos, filtering one or more photos, transforming one or more photos, and editing one or more photos. In some embodiments, the gesture comprises one or more of: a swipe, a flick, and a flip. In some embodiments, the gesture is applied on the touchscreen. In some embodiments, the application further comprises a software module automatically transferring or sharing one or photos to a second computing device. In further embodiments, the second computing device comprises one of the following: a server, a mobile phone, a mobile computer, a tablet, a watch, and a television. In some embodiments, the automatic transfer or sharing is preconfigured by the user. In some embodiments, the automatic transfer or sharing takes place in a condition based on one or more of the following: a time window, a bandwidth, a power level, a media type, a photo content, a location of photo being taken, and allowability of the second computing device. In some embodiments, the application further comprises a software module identifying an object in a photo. In some embodiments, identifying the object comprises identifying or tracking the object in two or more photos. In further embodiments, the object is in different views in at least two photos. In some embodiments, the object is in different sizes in at least two photos. In some embodiments, the application further comprises a software module printing a photo. In some embodiments, the printing the photo comprises allowing a selection of printout size. In some embodiments, the printing the photo comprises transmitting the photo to a computing device of a printing service provider.

In another aspect, disclosed herein are non-transitory computer-readable storage media encoded with a computer program including instructions executable by a processor to create an application for photo processing and organization, the media comprising: (a) a software module receiving a plurality of photos; (b) a software module presenting the plurality of the photos to a user based on an intelligent analysis on the plurality of the photos; (c) a software module removing duplicated photos; (d) a software module grouping the plurality of the photos based on similarity; and (e) a software module processing the plurality of the photos based on a gesture. In some embodiments, the plurality of the photos is received from one or more imaging devices. In some embodiments, the plurality of the photos is received from another computing device. In some embodiments, the presenting the plurality of the photos is based on a user defined gallery layout. In some embodiments, the intelligent analysis comprises a statistical analysis. In some embodiments, the intelligent analysis comprises analyzing a history of viewing, editing and sharing the plurality of the photos. In some embodiments, removing the duplicated photos comprises identifying similar or identical photos within a time windows. In some embodiments, removing the duplicated photos comprises generating a representative photo from similar or identical photos and deleting the similar or identical photos. In some embodiments, the representative photo comprises a photo selected from the similar or identical photos. In some embodiments, the representative photo comprises a photo synthesized from the similar or identical photos. In some embodiments, processing the plurality of the photos comprises one or more of: flipping one or more photos, deleting one or more photos, cropping one or more photos, filtering one or more photos, transforming one or more photos, and editing one or more photos. In some embodiments, the gesture comprises one or more of: a swipe, a flick, and a flip. In some embodiments, the gesture is applied on the touchscreen. In some embodiments, the application further comprises a software module automatically transferring or sharing one or photos to a second computing device. In some embodiments, the second computing device comprises one of the following: a server, a mobile phone, a mobile computer, a tablet, a watch, and a television. In some embodiments, the automatic transfer or sharing is preconfigured by the user. In some embodiments, the automatic transfer or sharing takes place in a condition based on one or more of the following: a time window, a bandwidth, a power level, a media type, a photo content, a location of photo being taken, and allowability of the second computing device. In some embodiments, the application further comprises a software module identifying an object in a photo. In some embodiments, identifying the object comprises identifying or tracking the object in two or more photos. In some embodiments, the object is in different views in at least two photos. In some embodiments, the object is in different sizes in at least two photos. In some embodiments, the application further comprises a software module printing a photo. In some embodiments, printing the photo comprises allowing a selection of printout size. In some embodiments, printing the photo comprises transmitting the photo to a computing device of a printing service provider.

In another aspect, disclosed herein are computer-implemented methods of photo processing and organization comprising: (a) receiving, by a computer, a plurality of photos; (b) presenting, by the computer, the plurality of the photos to a user based on an intelligent analysis on the plurality of the photos; (c) removing, by the computer, duplicated photos; (d) grouping, by the computer, the plurality of the photos based on similarity; and (e) processing, by the computer, the plurality of the photos based on a gesture made on a touchscreen or multi-touch screen. In some embodiments, the plurality of the photos is received from one or more imaging devices. In some embodiments, the plurality of the photos is received from another computing device. In some embodiments, presenting the plurality of the photos is based on a user defined gallery layout. In some embodiments, the intelligent analysis comprises a statistical analysis. In some embodiments, the intelligent analysis comprises analyzing a history of viewing, editing and sharing the plurality of the photos. In some embodiments, removing the duplicated photos comprises identifying similar or identical photos within a time windows. In some embodiments, removing the duplicated photos comprises generating a representative photo from similar or identical photos and deleting the similar or identical photos. In some embodiments, the representative photo comprises a photo selected from the similar or identical photos. In some embodiments, the representative photo comprises a photo synthesized from the similar or identical photos. In some embodiments, processing the plurality of the photos comprises one or more of: flipping one or more photos, deleting one or more photos, cropping one or more photos, filtering one or more photos, transforming one or more photos, and editing one or more photos. In some embodiments, the gesture comprises one or more of: a swipe, a flick, and a flip. In some embodiments, the gesture is applied on the touchscreen. In some embodiments, the application further comprises a software module automatically transferring or sharing one or photos to a second computing device. In some embodiments, the second computing device comprises one of the following: a server, a mobile phone, a mobile computer, a tablet, a watch, and a television. In some embodiments, the automatic transfer or sharing is preconfigured by the user. In some embodiments, the automatic transfer or sharing takes place in a condition based on one or more of the following: a time window, a bandwidth, a power level, a media type, a photo content, a location of photo being taken, and allowability of the second computing device. In some embodiments, the method further comprises identifying, by the computer, an object in a photo. In some embodiments, identifying the object comprises identifying or tracking the object in two or more photos. In some embodiments, the object is in different views in at least two photos. In some embodiments, the object is in different sizes in at least two photos. In some embodiments, the method further comprises printing a photo. In some embodiments, printing the photo comprises allowing a selection of printout size. In some embodiments, printing the photo comprises transmitting the photo to a computing device of a printing service provider.

In another aspect, disclosed herein are platforms comprising: at least one mobile processor configured to provide a mobile photo sharing application comprising: a software module presenting an interface allowing a user to select one or more photos from a library of photos stored locally to the at least one mobile processor; a software module uploading one or more selected photos to a server photo sharing application, the photos encrypted during the upload; a software module presenting an interface allowing the user to select one or more sharing mechanisms; and at least one server processor configured to provide the server photo sharing application comprising: a software module publishing a URL via one or more selected sharing mechanisms to one or more recipients, the URL providing access to the uploaded photos; a software module regulating access to the uploaded photos by presenting the uploaded photos in an obscured form, the obscured form replaced by a clear form upon interaction of a recipient, the clear form available during a countdown period and upon expiration of the countdown period, the photo replaced by an ad. In some embodiments, the mobile photo sharing application further comprises a software module presenting an interface allowing a user to select one or more recipients. In some embodiments, the sharing mechanisms comprise email, SMS, social media, file sharing, or a combination thereof. In some embodiments, the obscured form comprises blurred, covered, distorted, pixelated, or a combination thereof. In some embodiments, the countdown period is user-configurable.

In another aspect, disclosed herein are computer-implemented methods of photo sharing comprising: presenting, by a first computer, an interface allowing a user to select one or more photos from a library of photos stored at the first computer; uploading, by the first computer, one or more selected photos to a server photo sharing application, the photos encrypted during the upload; presenting, by the first computer, an interface allowing the user to select one or more sharing mechanisms; publishing, by a second computer, a URL via one or more selected sharing mechanisms to one or more recipients, the URL providing access to the uploaded photos; and regulating, by the second computer, access to the uploaded photos by presenting the uploaded photos in an obscured form, the obscured form replaced by a clear form upon interaction of a recipient, the clear form available during a countdown period and upon expiration of the countdown period, the photo replaced by an ad. In some embodiments, the method further comprises presenting, by the first computer, an interface allowing a user to select one or more recipients. In some embodiments, the sharing mechanisms comprise email, SMS, social media, file sharing, or a combination thereof. In some embodiments, the obscured form comprises blurred, covered, distorted, pixelated, or a combination thereof. In some embodiments, the countdown period is user-configurable.

### BRIEF DESCRIPTION OF THE DRAWINGS

FIG. 1 shows a non-limiting example of gallery layouts.

FIG. 2 shows a non-limiting example of a photo album.

FIG. 3 shows a non-limiting example of photo transfer or backup or sharing on a cloud environment.

FIG. 4 shows a non-limiting example of an interface for presenting a single photo.

FIG. 5 shows a non-limiting example of editing photos based on gestures applied on a touchscreen.

FIG. 6 shows a non-limiting example of editing icons of photo processing and management.

FIG. 7 shows a non-limiting example of printing photos from a mobile device.

FIG. 8 shows a non-limiting example of making payments for printing photos.

FIG. 9 shows a non-limiting example of an interface for displaying and editing a user profile.

FIG. 10 shows a non-limiting example of system architecture.

FIG. 11 shows a non-limiting example of various views on photos.

FIG. 12 shows a non-limiting example of various user interfaces.

FIG. 13 shows a non-limiting example of notification features.

FIG. 14 shows a non-limiting example of various photo viewing modes.

FIG. 15 shows a non-limiting example of a photo gallery based on time.

FIG. 16 shows a non-limiting example of a photo gallery based on events.

FIG. 17 shows a non-limiting example of a photo gallery based on an automatic layout.

FIG. 18 shows a non-limiting example of a photo gallery with an editing feature enabled.

FIG. 19 shows a non-limiting example of a photo gallery in a cluster mode.

FIG. 20 shows a non-limiting example of a photo gallery in a cluster mode with gesture-based editing enabled.

FIG. 21 shows a non-limiting example of a photo gallery with smart cleanup.

FIG. 22 shows a non-limiting example of a photo gallery with smart cleanup and gesture-based editing.

FIG. 23 shows a non-limiting example of a photo with various processing icons enabled.

FIG. 24 shows a non-limiting example of a photo gallery with a menu of photo processing options.

FIG. 25 shows a non-limiting example of a photo to be shared on a social network media.

FIG. 26 shows a non-limiting example of a photo to be shared on a social network media, with gesture-based editing enabled.

FIG. 27 shows a non-limiting example of a photo with an option to flip the photo.

FIG. 28 shows a non-limiting example of a photo with social media feed.

FIG. 29 shows a non-limiting example of a photo for a framed printing.

FIG. 30 shows a non-limiting example of a photo for a framed printing with gesture-based editing enabled.

FIG. 31 shows a non-limiting example of a photo for a poster printing with size selection.

FIG. 32 shows a non-limiting example of payment processing for photo printing.

FIG. 33 shows a non-limiting example of a confirmation of a photo printing order.

FIG. 34 shows a non-limiting example of a photo gallery where a user shoot multiple pictures to ensure a good one.

FIG. 35 shows a non-limiting example of removing duplicated photos.

FIG. 36 shows a non-limiting example of a computing system.

FIG. 37 shows a non-limiting example of a network of computing devices with technologies disclosed herein.

FIG. 38 shows a non-limiting example of a photo gallery with sharing features.

FIG. 39 shows a non-limiting example of a photo gallery including an introductory screen explaining a sharing feature comprising photo upload and sharing via a published URL, wherein the photo disappears after the recipient(s) view (e.g., foto fade).

FIG. 40 shows a non-limiting example of a photo gallery including a dialog allowing a user to select a sharing mode.

FIG. 41 shows a non-limiting example of a photo gallery including an introductory screen explaining a foto fade sharing mode.

FIG. 42 shows a non-limiting example of a photo gallery including a sharing drawer allowing a user to select a communication mechanism for a sharing feature.

FIG. 43 shows a non-limiting example of photos shared via a foto fade sharing mode, wherein the shared photos are obscured prior to viewing by the recipient in a mobile app.

FIG. 44 shows a non-limiting example of a photo shared via a foto fade sharing mode, wherein the shared photo is unobscured prior and a viewing countdown has begun in a mobile app.

FIGS. 45 and 46 show non-limiting examples of photos shared via a foto fade sharing mode, wherein the shared photos are replace by ads after a viewing countdown has elapsed in a mobile app.

FIG. 47 shows a non-limiting example of photos shared via a foto fade sharing mode, wherein the shared photos are obscured prior to viewing by the recipient in a web browser.

FIG. 48 shows a non-limiting example of a photo shared via a foto fade sharing mode, wherein the shared photo is unobscured prior and a viewing countdown has begun in a web browser.

FIGS. 49 and 50 show non-limiting examples of photos shared via a foto fade sharing mode, wherein the shared photos are replace by ads after a viewing countdown has elapsed in a web browser.

### DETAILED DESCRIPTION OF THE TECHNOLOGY

Existing social media services offer ways to share photos and comments with large groups of social friends; however, social sites fail to adequately accommodate the deeper more meaningful conversations and photo sharing that happens with close friends and family. SMS/MMS and email still drive a large portion of the close friend and family photo conversations but fall short of user expectations with large groups of photos and the continuity needed around that group sharing. Moreover, existing social media services put photo files into circulation and prevent a sharing user from maintaining control over republication and distribution of photos.

Current mobile applications also have several disadvantages. Most users' photo libraries are cluttered with duplicates and current galleries are limited to organization based on time and place photos are taken. Organizing a full gallery on a mobile device, such as a phone, takes too long and is too difficult. For example, de-duplication and removal of unwanted photos is cumbersome. Moreover, finding and sharing the “best photos” from a series of similar photos is a challenge.

What is needed, to alleviate the shortcomings of existing technologies, is an application that: delivers an improved viewing experience optimized for sharing with one or many people around a photo conversation; uniquely combines in-line chat with the photo story; offers features ideal for creating, viewing, and chatting around group events; and facilitates ordering personal print products, which is the natural outcome when curated photos and text are presented together around shared experiences.

Accordingly, described herein, in various embodiments, are systems, media, and methods comprising: group photo sharing features with built-in chat that allows user to find friends and request their latest photos from a group event and filter to see all photos shared by one member of the group; an enhanced photo viewing experience with swipe gestures, dual scrolling and flip to see more and the ability to easily create playlists of favorite photos and memories and publish to share with friends and family; and an extensive, cross-platform print service offering a simple creative process that produces great products.

In one aspect, described herein is a smart photo gallery. In some embodiments, a smart photo gallery includes an algorithm for ranking photos based on user activity to make it easier for users to find the photos they view, share, or edit frequently. In some embodiments, a smart photo gallery includes a smart cleanup feature. In further embodiments, a smart cleanup feature allows for automated organization and cleanup of a photo gallery by automatically creating a highlight reel of best photos and lowlight reel of duplicate or worst photos for auto removal. In various further embodiments, a smart cleanup feature uses Mosaic AI and Clustering to find the best photos to quickly organize into playlists and automatically surfaces the most shared, edited, and viewed photos. In various further embodiments, a smart cleanup feature allows a user to: hover to quickly preview and view the best photos; swipe to add to playlist and flip to view metadata; auto de-duplicate and remove unwanted photos; and perform auto-recognition of similar photos to help find the best one to keep.

In another aspect, described herein are photo playlists. In some embodiments, a photo playlist includes features to easily create playlists of favorite photos and memories and publish to share with friends and family. In further embodiments, a photo playlist provides a simple way to share multiple photos. In various further embodiments, a photo playlist allows a user to: easily organize and create playlists of favorite photos and memories; generate a frictionless URL that can be shared across all devices and mediums. In some embodiments, a photo playlist allows a user to dynamically create a URL and display selected photos in a user-friendly format.

In another aspect, described herein is a photo vault. In some embodiments, a photo vault includes features to automatically backup and preserve cherished photo memories by uploading original photos in the background and storing them in the cloud. In various further embodiments, a photo vault provides: auto-backup technology to permanently store originals; auto-uploading of photos in the background on mobile operating systems such as Android and iOS; access to the vault anywhere (desktop, smartphones, tablets, mobile-web, TV, etc.); and features to schedule smart back-ups. In some embodiments, a photo vault provides privacy and allows a user to hide and mask photos across mobile operating systems.

In yet another aspect, described herein are personalized print features. In some embodiments, personalized print features allow creation of personalized printed products like photo books, canvas prints, greeting cards, and home decor. In further embodiments, personalized print features allow users to share playlists with friends and family so they can order print products. In various embodiments, personalized print features provide the ability to: order print products from anywhere (desktop, smartphones, tablets, mobile-web, TV, etc.); convert digital memories to physical prints delivered directly to a user's home or for same-day pick of prints at a retail outlet; access a full catalog of print products including prints, canvas, premium lay-flat photo books, greeting cards, home decor, and creative gifts.

In yet another aspect, described herein are photo sharing features. In some embodiments, photo sharing features allow a user to securely share photos without losing control of their media files. In other words, the sharing user can select the recipients as well as the sharing mechanisms and allow access to the photos for a limited time (e.g., only during a countdown period). In some embodiments, photo sharing features provide access to shared photos via a URL, which is accessible to many a multitude of applications and devices. In some embodiments, photo sharing features replace shared photos, after expiration of, for example, a countdown period, with an ad to facilitate a monetization mechanism for the feature.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, “photo” means a digital image file, including still images, animated images, and video images, with or without audio.

### Photo Presentation

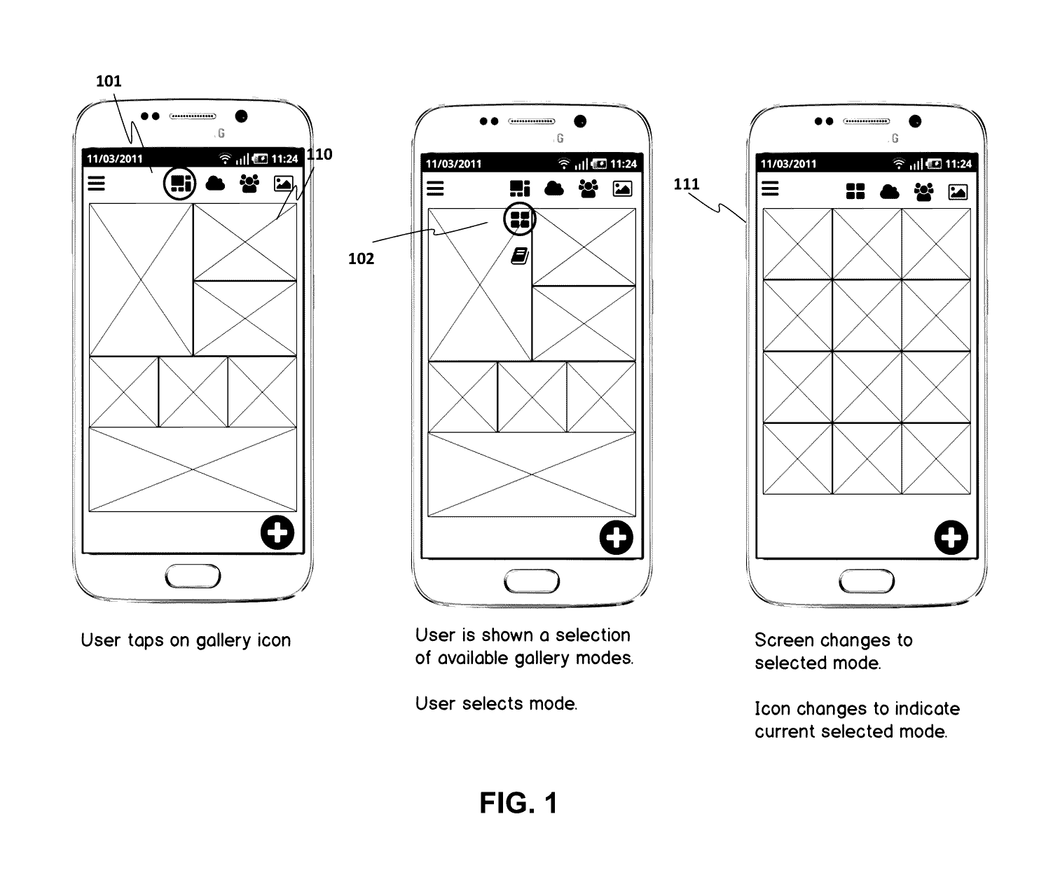

In some embodiments, the systems, media, methods, and applications described herein include a photo presentation module. In some embodiments, the photo presentation module displays one or more photos to a user. In some embodiments, the photo presentation module displays a plurality of photos based on an automatic configuration. Referring to FIG. 1, a screen 110 displays seven photos, which are not in the same size and whose corresponding layout is shown at icon 101. Nevertheless, a user can tap on the gallery icon 101 and select one out of available layout options. In this case, the layout mode 102 lays the photos with an equal size. After the user selects the layout mode 102, the screen 111 displays twelve photos with a same size.

In some embodiments, a photo presentation module displays a plurality of the photos based on an intelligent analysis on the plurality of the photos. In some embodiments, an intelligent analysis evaluates photos based on time and location information. In some embodiments, the analysis is based on contents of photos.

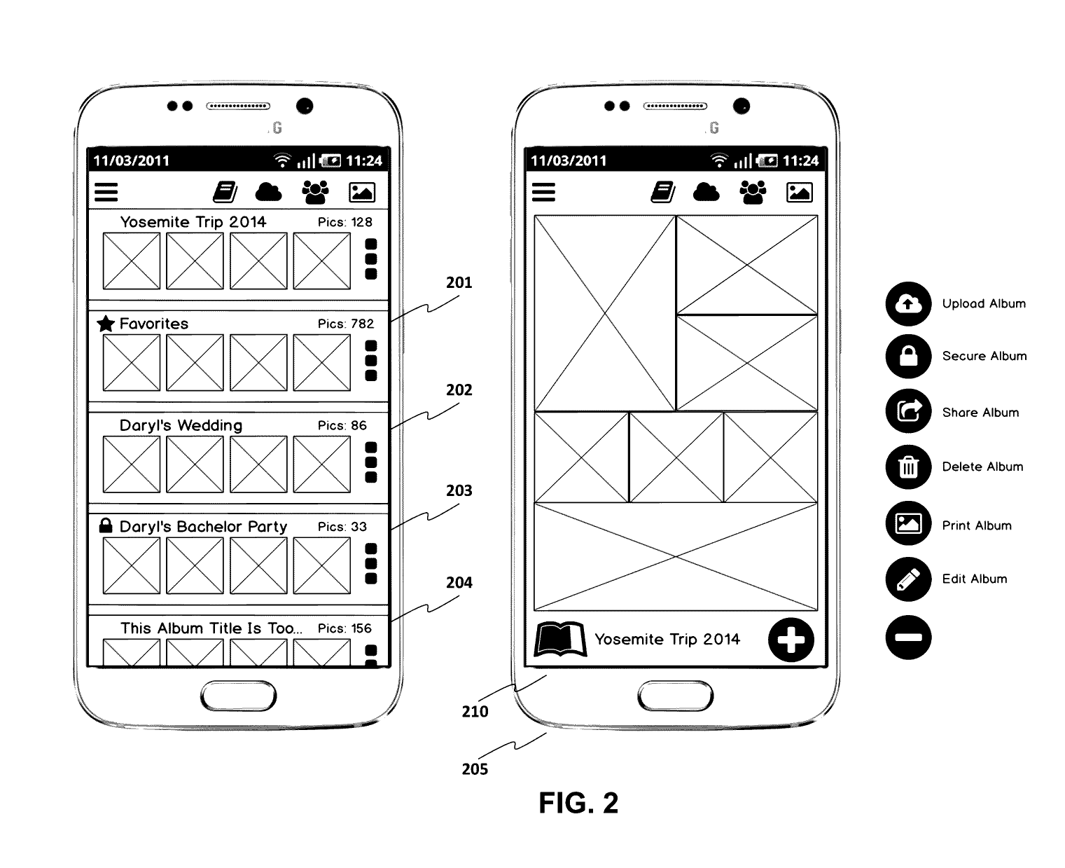

In some embodiments, a photo presentation module displays one or more albums. Referring to FIG. 2, a plurality of albums is displayed. For instance, Yosemite Trip 2014 with 128 photos (201), Favorites with 782 photos (202), Daryl's Wedding with 86 photos (203), and Daryl's Bachelor Party with 33 photos (204). In some embodiments, when a user selects a specific album, the photos in the album are displayed based on a layout mode. In FIG. 2, the album of Yosemite Trip 2014 is selected, and the photos are displayed on the screen 210 and the album title 205 is displayed. Further, a user can tap on the screen and perform further actions on the album, such as uploading, securing, sharing, deleting, printing, and editing.

### Photo Transfer

In some embodiments, the systems, media, methods, and applications described herein include a photo transfer module. In some embodiments, a photo transfer module is configured to automatically transfer or share one or photos to a second computing device. Examples of a second computing device includes, but not limited to, a server, a mobile phone, a mobile computer, a tablet, a watch, and a television. In further embodiments, automatic transfer or sharing is preconfigured by a user. In still further embodiments, automatic transfer or sharing takes place in a condition based on one or more of the following: a time window, a bandwidth, a power level, a media type, photo content, a location of photo being taken, and access allowability of the second computing device.

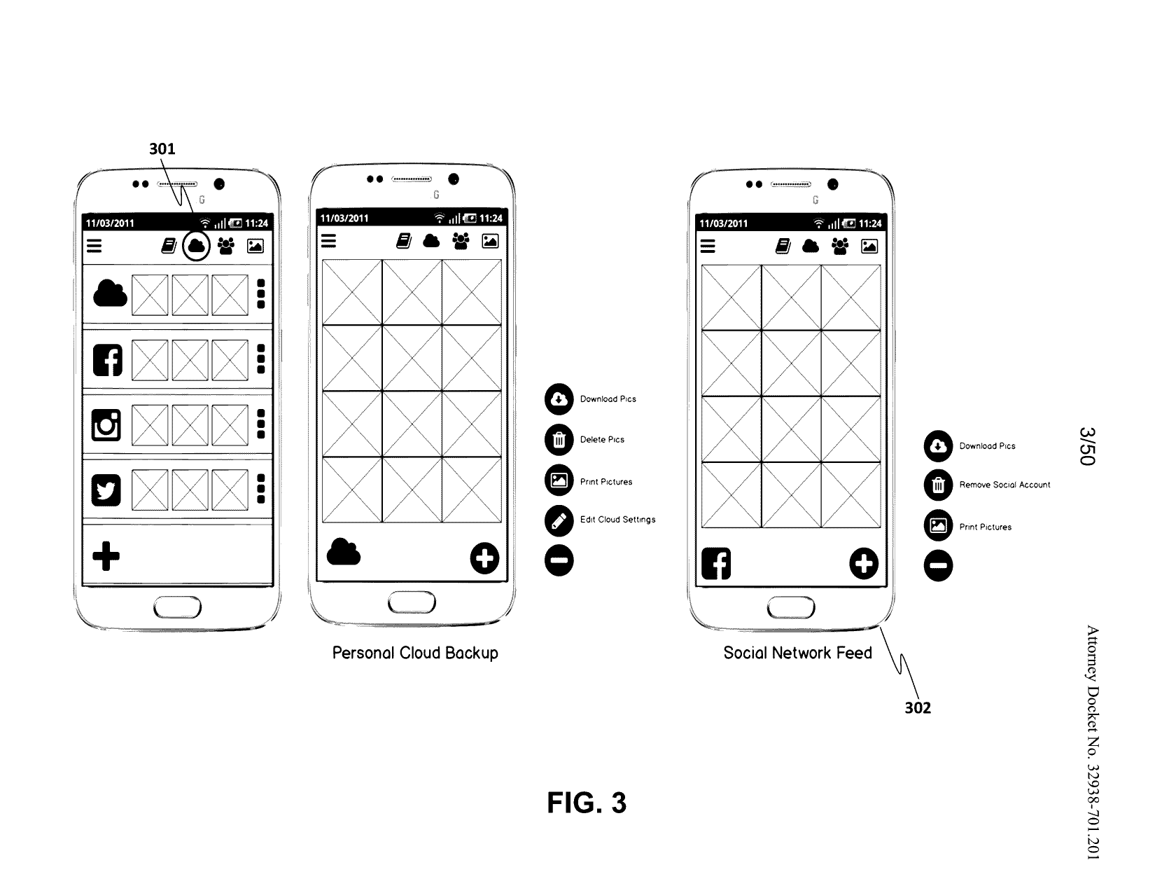

Referring to FIG. 3, a cloud icon 301 is included on the user interface. When a user taps the icon 301, a list of options for photo transfer is shown, such as personal backup on a cloud, sharing on a social network (e.g., Facebook, Twitter, Instagram, etc.), and transferring to another computing device. On the other hand, a photo transfer module is configured to receive photos from other devices, such as receiving photos from social network feed 302.

### Photo Processing

In some embodiments, the systems, media, methods, and applications described herein include a photo processing module. In some embodiments, a photo processing module allows a user to edit a photo. Examples of photo editing includes: flipping one or more photos, deleting one or more photos, cropping one or more photos, filtering one or more photos, transforming one or more photos, and deleting one or more photos. In further embodiments, photo editing is based on a gesture applied on a touchscreen, such as a swipe, a flick, and a flip.

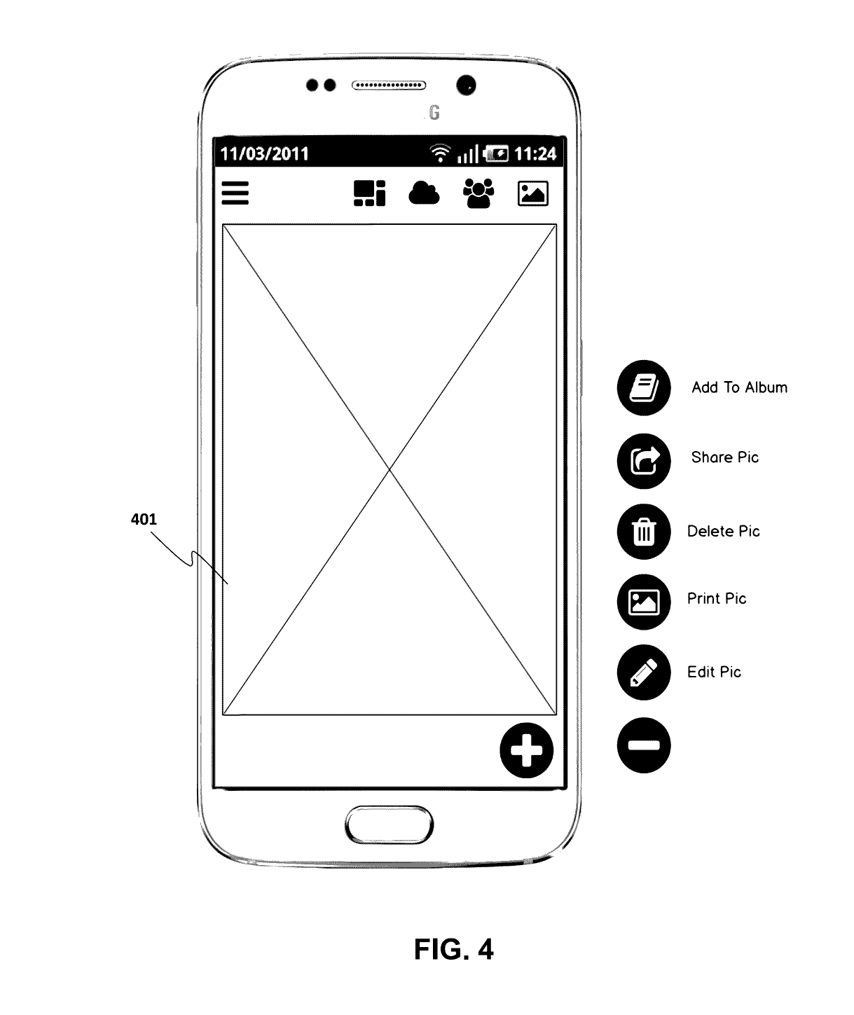

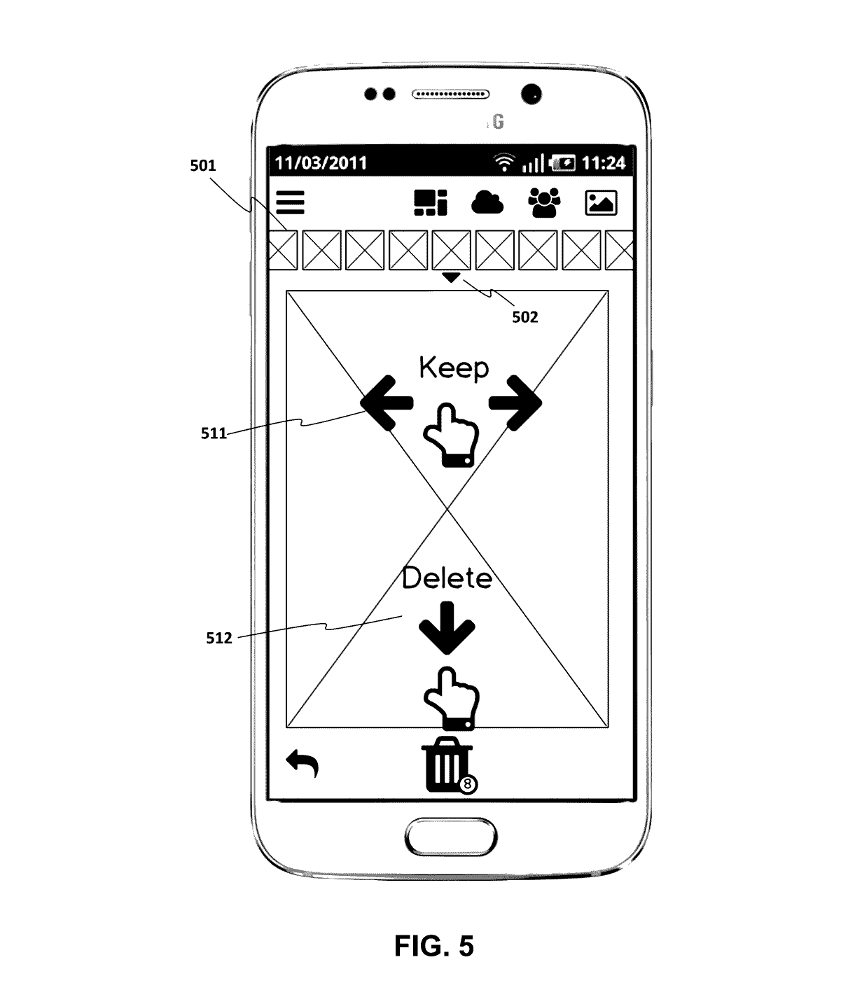

Referring to FIG. 4, in some embodiments, a single photo 401 is displayed for editing purpose. FIG. 5 shows an embodiment for editing. A series of photos 501 (e.g., in a same album, or with same features based on an intelligent analysis) is displayed on top. An indicator 502 indicates which photo is under editing. Further, when wiping left or right 511, the photo is kept; when wiping down 512, the photo is deleted.

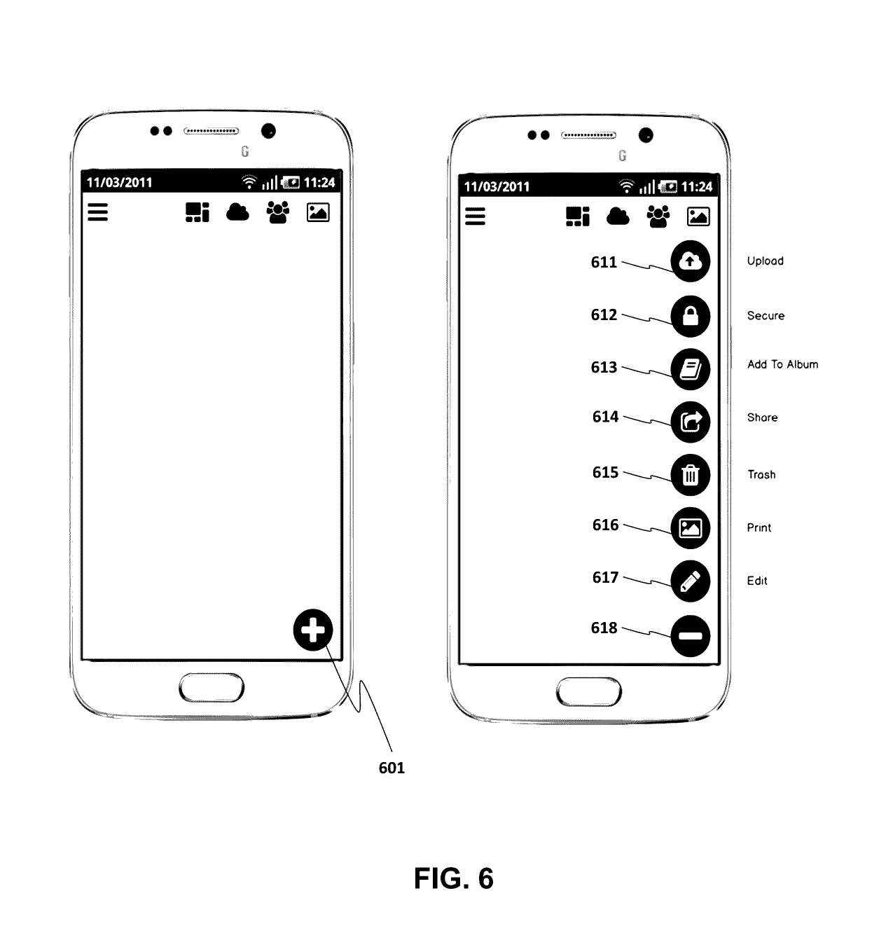

FIG. 6 shows an embodiment where operations on photos or albums are based on icons. When a user clicks an icon 601 with a plus sign, a plurality of icons is popped up. For example, icon 611 for uploading a photo, icon 612 for securing a photo, icon 613 for adding a photo to an album, icon 614 for sharing a photo or an album to a social network or to another computing device, icon 615 for trashing a photo, icon 616 for printing a photo, and icon 617 for editing a photo. Further, when clicking the icon 618 with a minus sign, the plurality of icons will disappear.

In some embodiments, a photo processing module analyzes photos and removes duplicated photos. In some embodiments, a photo processing module groups the plurality of the photo based on similarity. In further embodiments, removing the duplicated photos comprises identifying similar or identical photos within a time windows and/or identifying objects or contents in the photos. In still further embodiments, removing the duplicated photos comprises generating a representative photo from similar or identical photos and deleting the similar or identical photos. In additional embodiments, the representative photo is a photo selected from the similar or identical photos; alternatively, the representative photo is a photo synthesized from the similar or identical photos.

In some embodiments, a photo processing module comprises an intelligent analysis on photos. In further embodiments, an intelligent analysis comprises a statistical analysis. In additional embodiments, the intelligent analysis comprises analyzing a history of viewing, editing and sharing the plurality of the photos. In some embodiments, an intelligent analysis comprises identifying an object on one or more photos. Further, identifying the object comprises tracking the object on two or more photos. In some cases, the object under tracking has an identical view across the photos, or has different views such as different sizes, rotating, and flipping, etc.

### Photo Printing

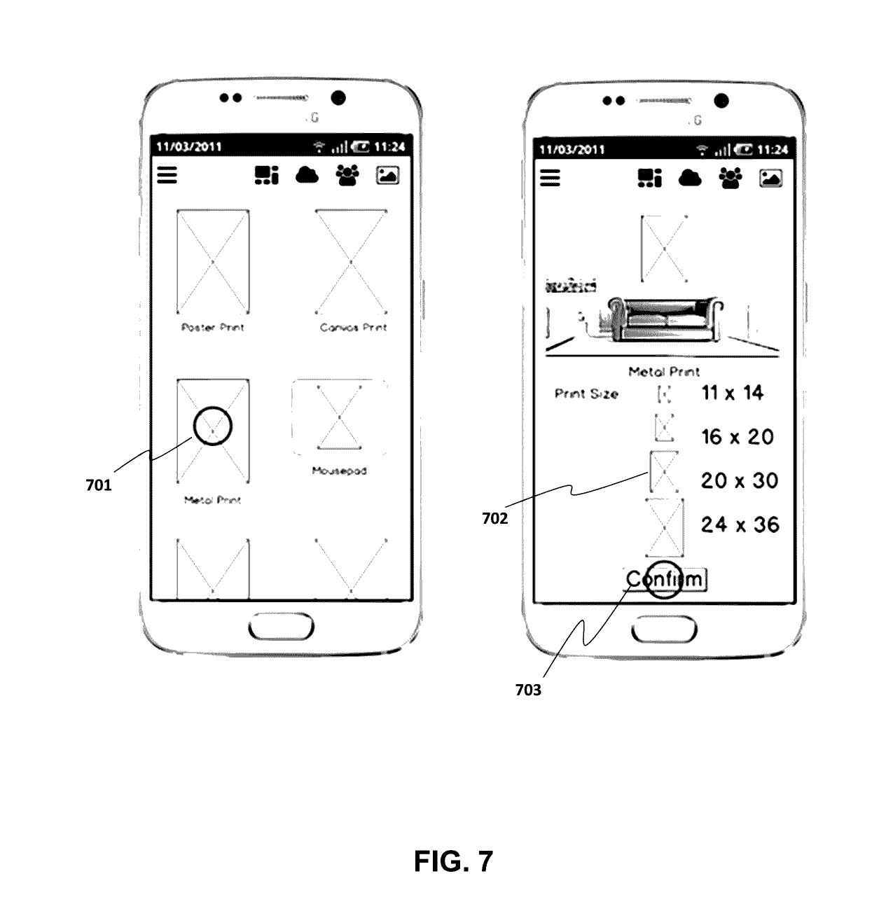

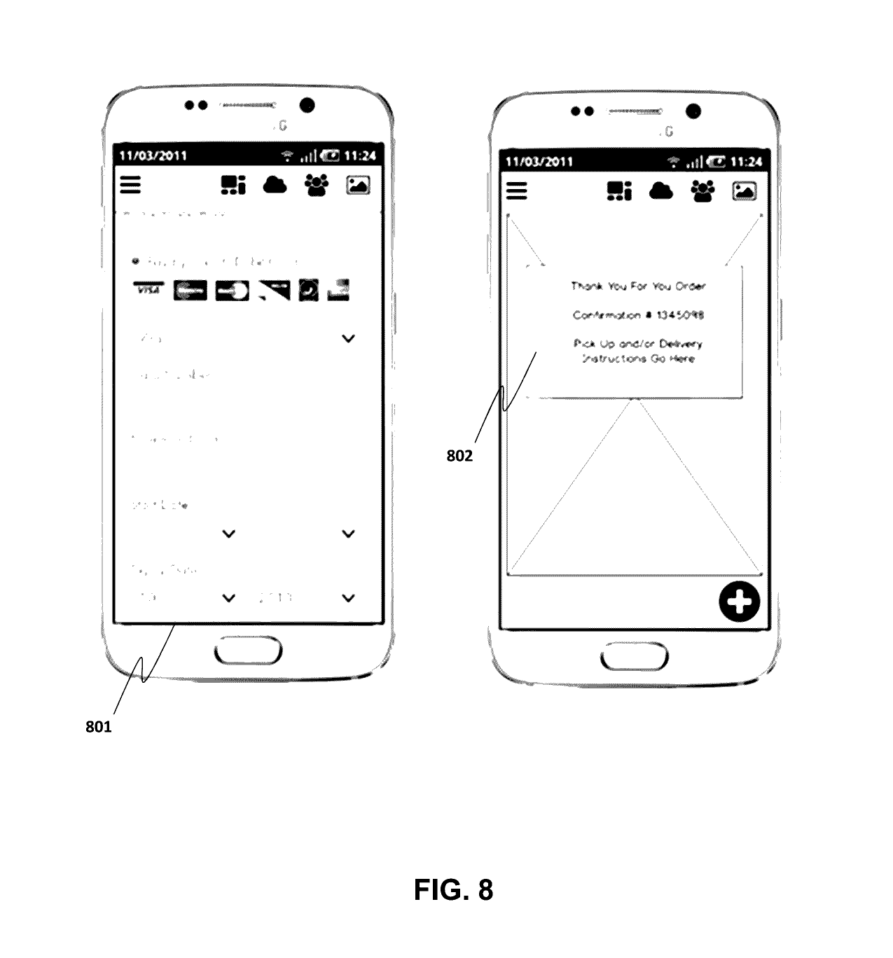

In some embodiments, the systems, media, methods, and applications described herein include a photo printing module. When clicking a printing icon 616 shown in FIG. 6, a user is allowed to select one or more photos for printing. Referring FIG. 7, a plurality of photos is shown, and a user selects photo 701. Next, a user selects the size 702 for the printing and makes confirmation 703 of the printing. In a further embodiment shown in FIG. 8, a payment processing 801 is configured, and a final confirmation message 802 is presented.

### User Profile

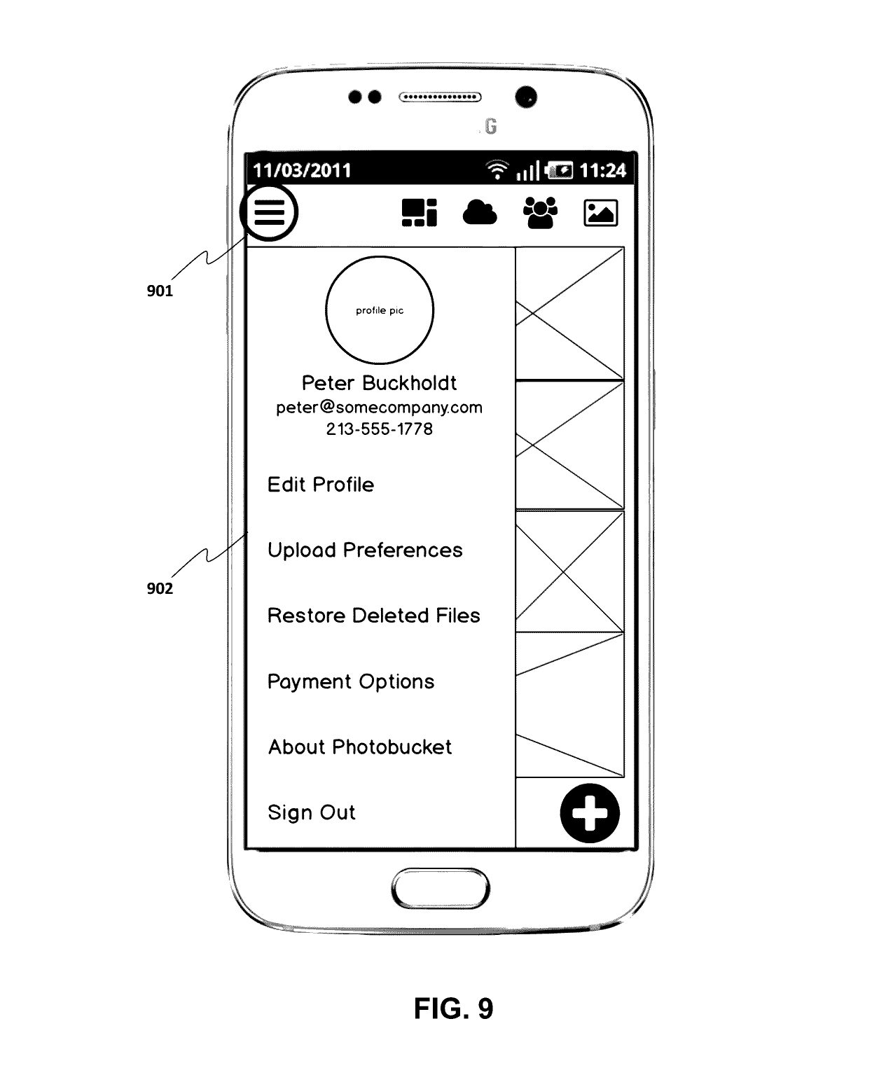

In some embodiments, the systems, media, methods, and applications described herein include a user profile. Referring to FIG. 9, when clicking a menu 901, the screener 902 shows a user's profile (including name, email, phone number, and etc.) and allows the user to edit profile, configure upload preferences and payment options, and restore deleted files.

### Photo Sharing

In some embodiments, the systems, media, methods, and applications described herein include photo sharing features. In a particular embodiment, the photo sharing feature is a foto fade feature. In further embodiments, a foto fade feature allows users who have downloaded a proprietary native mobile application to share photos that expire with minimal friction. In some embodiments, no friend requests or registration are needed to share photos via a foto fade feature.

In a foto fade feature, in some embodiments, upon selecting one or more photos, the application immediately uploads the content to a proprietary cloud and generates a unique URL. This URL can be shared across any device and platform via mechanisms such as SMS, email, Facebook, Dropbox, Messenger, and the like, to one or multiple individuals as recipients.

In a foto fade feature, in some embodiments, once a recipient views the link they are able to access and view each photo for a set period of time—one photo at a time. Upon viewing the URL the device is fingerprinted and the device no longer has access to the images once they expire. If the recipient reloads the page, the URL is expired based on the device fingerprint. A recipient is able to view the photos without downloading an app, responding to an invitation, or registering to view the content.

Further, in a foto fade feature, in some embodiments, once the set viewing period expires, each photo is replaced with an ad. This provides a monetization mechanism to allow a business to provide such a feature without charging users any fee.

### Digital Processing Device

In some embodiments, the systems, media, methods, and applications described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the systems, media, methods, and applications disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, media, methods, and applications disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™ PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the systems, media, methods, and applications disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, media, methods, and applications disclosed herein include one or more databases, or use of the same. In view of the disclosure provided herein, those of skill in the art will recognize that many databases are suitable for storage and retrieval of user, photo, playlist, and/or friend information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### System Architecture

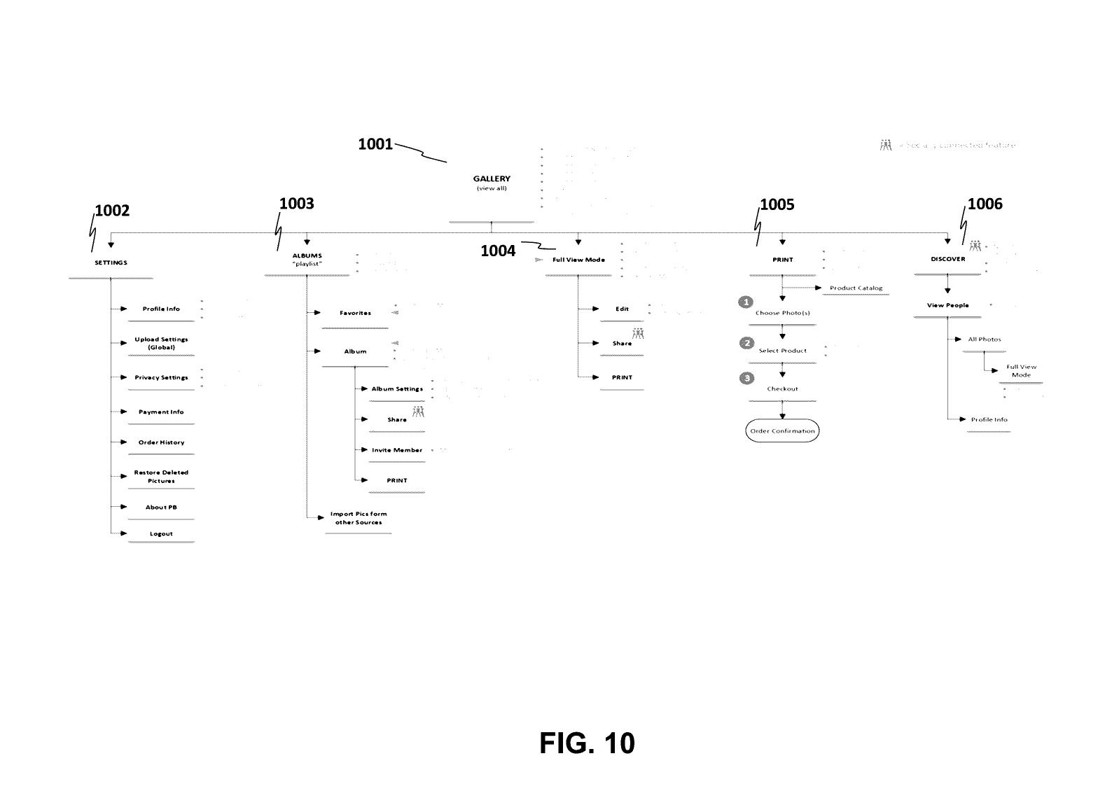

FIG. 10 shows an example of system architecture. Overall, the system provides a photo gallery 1001, including search, sort and filter AI options. Further, the gallery 1001 allows a user to select to album, select to delete, select to share, and select to deduplicate. The gallery has different modes for viewing photos. The gallery also includes visual indictors, such as upload vs. not, added to album, and favorites.

The system includes a setting function 1002. In the setting, a user can configure various aspects: profile info, upload setting, privacy setting, payment info, order history, restoration of deleted files, and logout.

The system includes an album or a playlist 1003. A user can search, sort, and filter photos. A user is allowed to edit or create an album. A user is allowed to edit, add or move favorite photos. Further, an album has the following setting: privacy (e.g., public, private, or secrete/vault), upload setting, invite another member, and print. In addition, an album is configured to import photos form another source, e.g., social network or cloud.

The system includes a full view mode 1004, where a user can add to favorites, add to an album, like, comment, tag, delete, crop, filter, apply an effect, share, and print.

The system includes a printing function 1005. A printer is local, or means a professional photo development service. Printing function includes showing best-selling photos, promotions, and viewing catalog. The printing function has three steps: choose one or more photos, select a product (e.g., template, preview), and checkout.

The system includes a discover function 1006. Examples include newsfeed, search (on photos or people or objects), and viewing people. Viewing a person includes viewing the person's profile or photos, which can be in a full view mode or partial view mode. In a full view mode, the user can comment or like.

### Example 2

### Photo Display Layouts

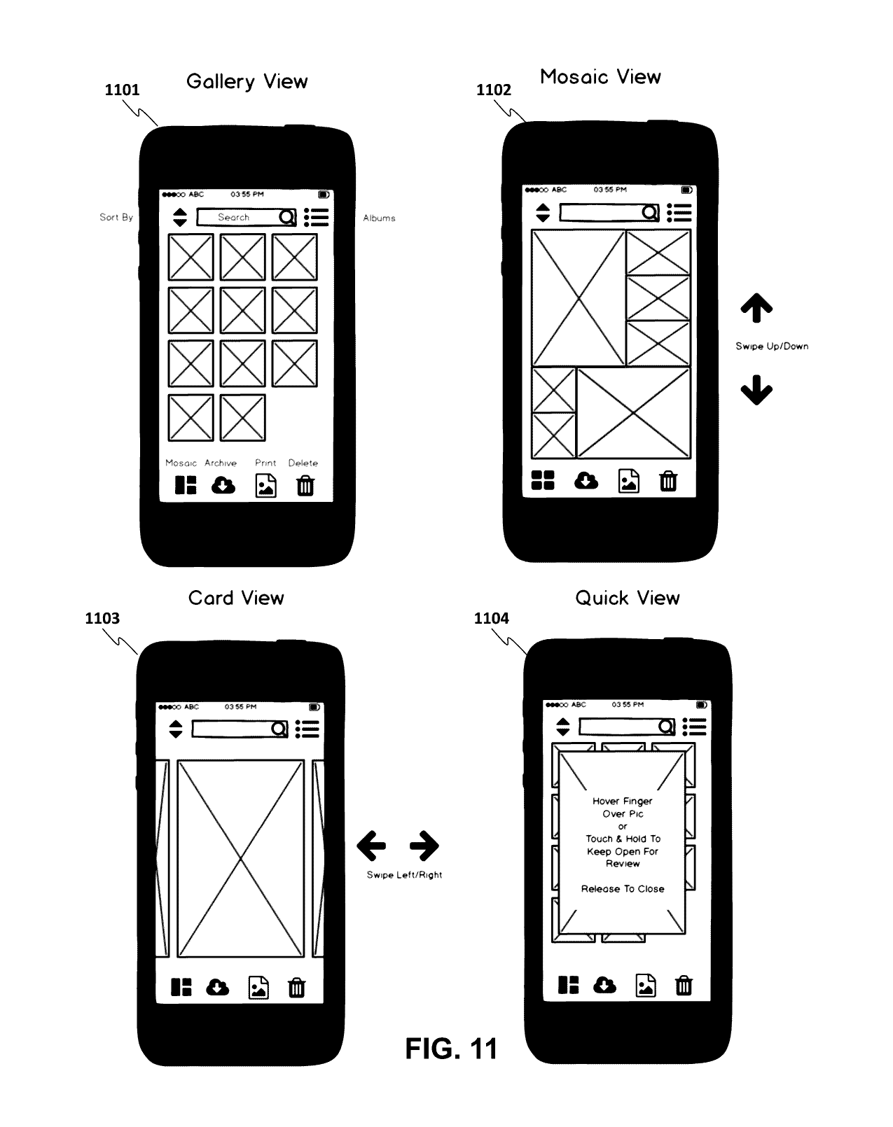

The technologies disclosed herein enable a variety of ways to present photos. FIG. 11 shows a gallery view 1101, a mosaic view 1102, a card view 1103, and a quick view 1104. In some embodiments, a system automatically evaluates contents of photos and/or the number of photos to evaluate a best layout for display.

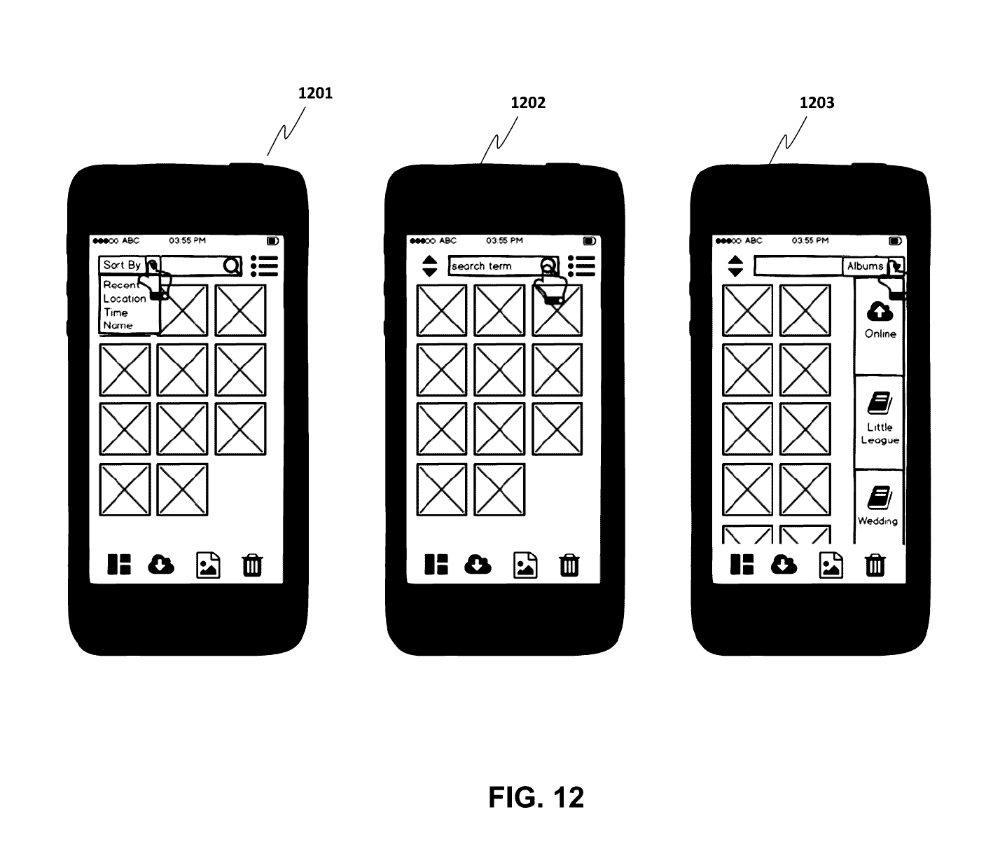

Further, a user interface is designed along with a layout. Referring FIG. 12, in some embodiments, the layout comprises a “sort by” function 1201 to allow a user to sort photos or albums. In some embodiments, the layout comprises a “search” function 1202 to allow a user to search photos or albums. In some implementations, a search is based on keywords attached to the photos. In some applications, a search is based on contents in photos; for example, a search term comprises “sun,” and the system performs object recognition to identify photos with the sun in their scenes.

In some embodiments, the layout comprises an “album” function 1203 to allow a user to process albums, such as uploading to cloud. In some designs, the album function allows a user to retrieve a particular album.

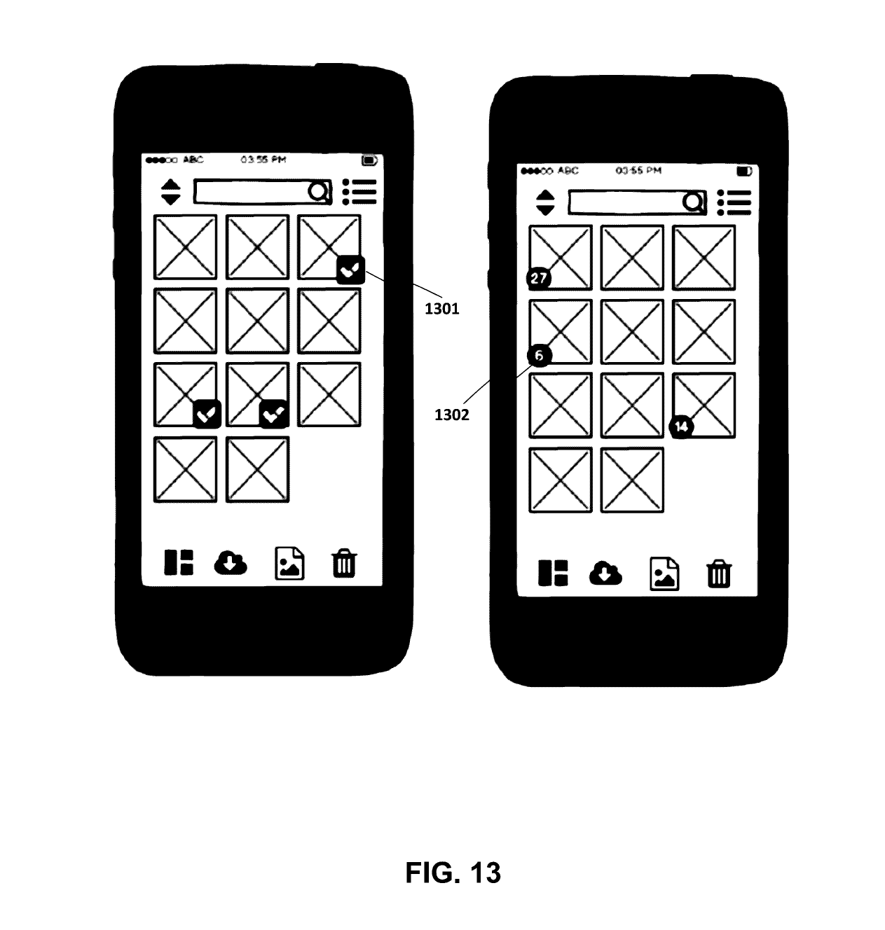

In some embodiments, the layout comprises a notification feature. Referring to FIG. 13, when photos are selected by a user for any processing, the interface shows a notification 1301 of being checked. In some embodiments, a notification 1302 indicates the number of photos in a group. The group can be based on one or more of the following: time, location, contents of photos, people, scenes, and duplicated photos.

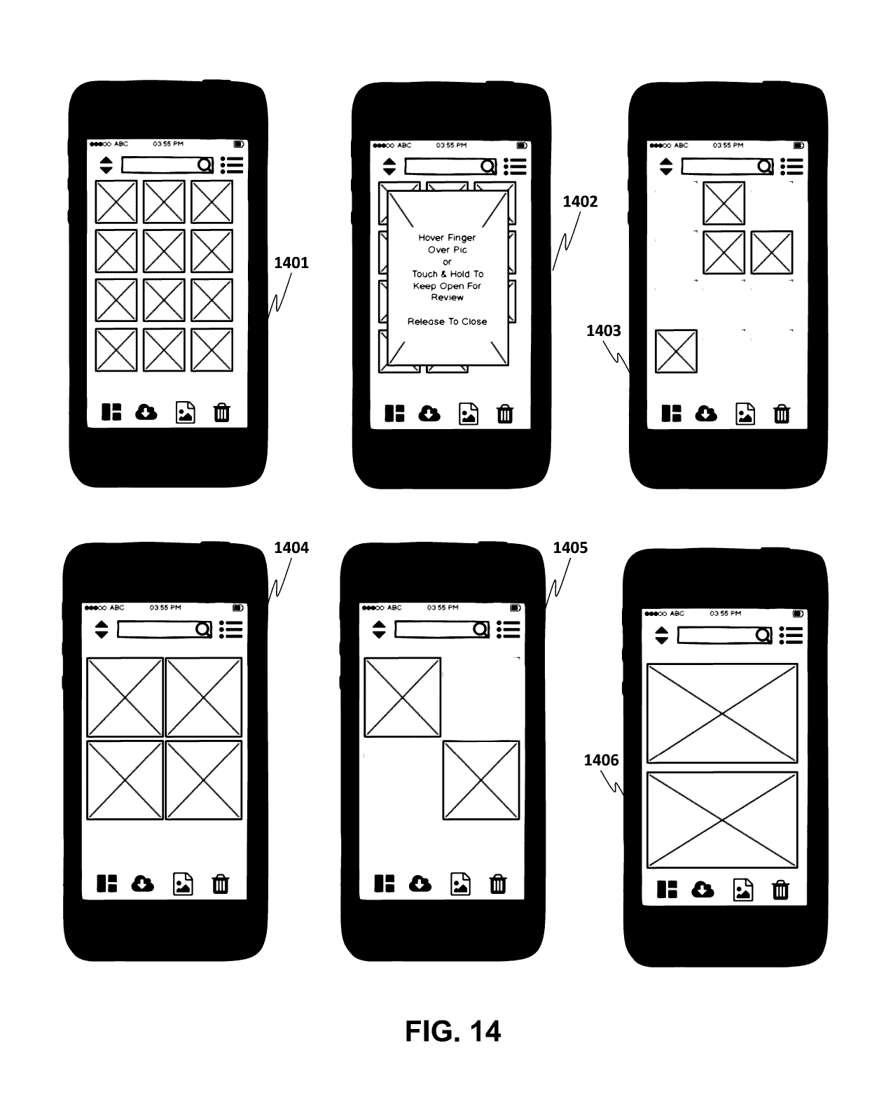

In some embodiments, the layout comprises a cluster view or an album view, where a user can perform editing. Referring to FIG. 14, individual photos can be views as a cluster (1401); photos can be viewed, edited, selected (1402); photos can be added or added (1403); photos can re-shuffle and become larger to take up more screen space, making themselves easier to view (1404); the photos can be deleted or added after re-shuffling (1405); the system can further re-shuffle and make photos even larger (1406).

### Example 3

### Photo Galleries

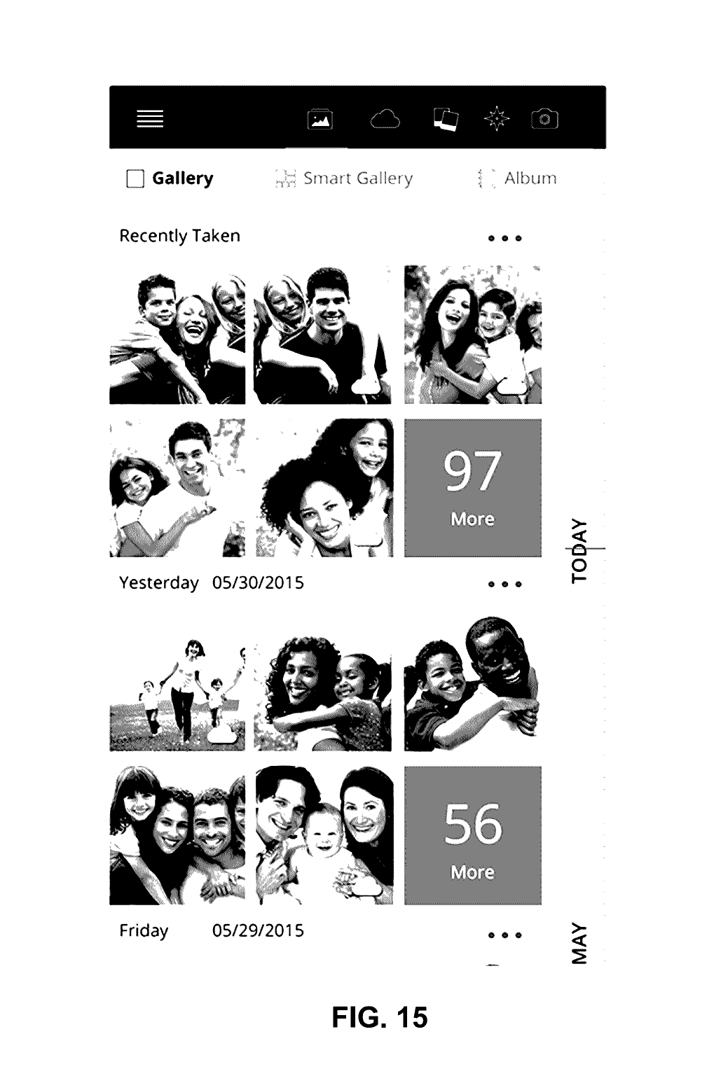

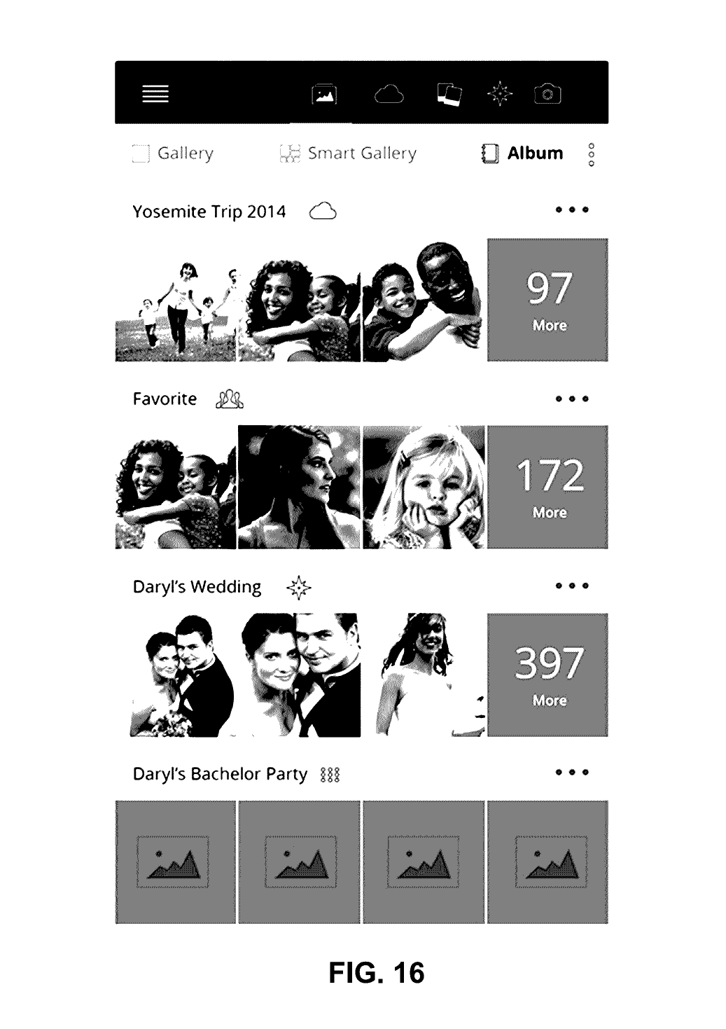

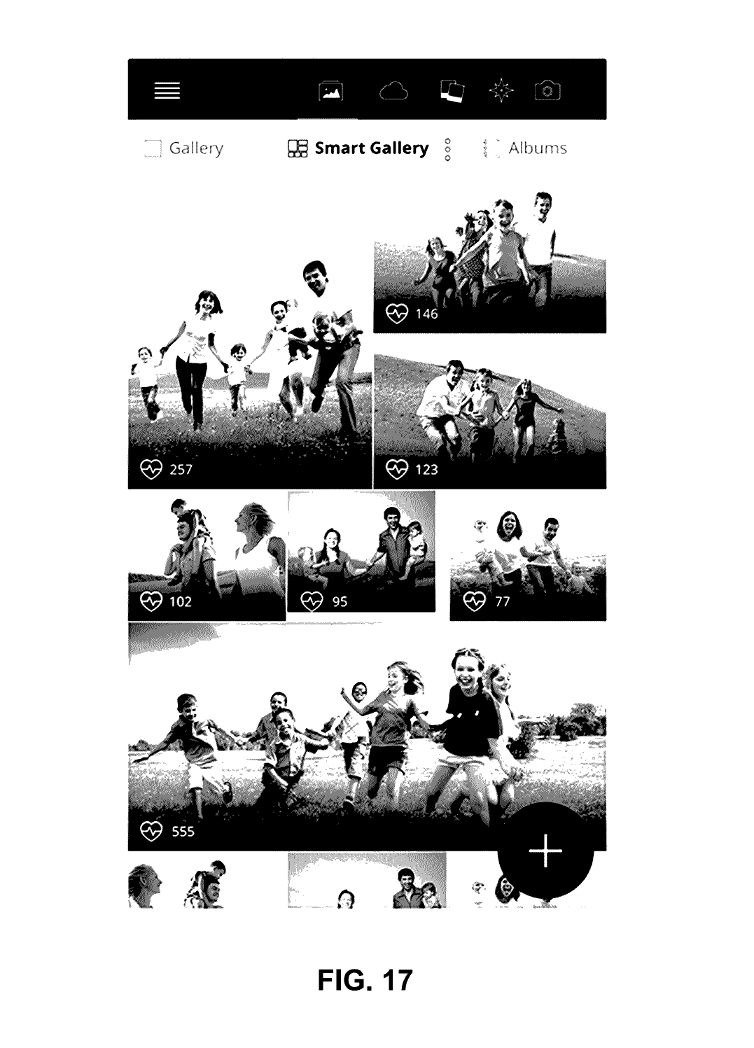

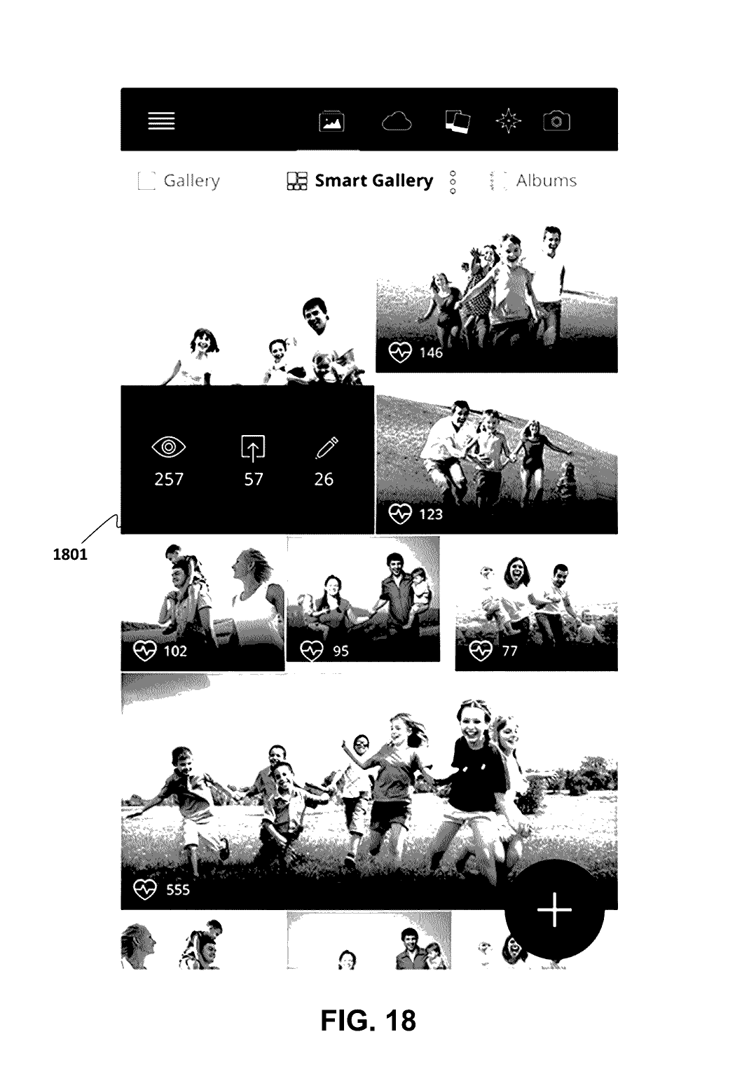

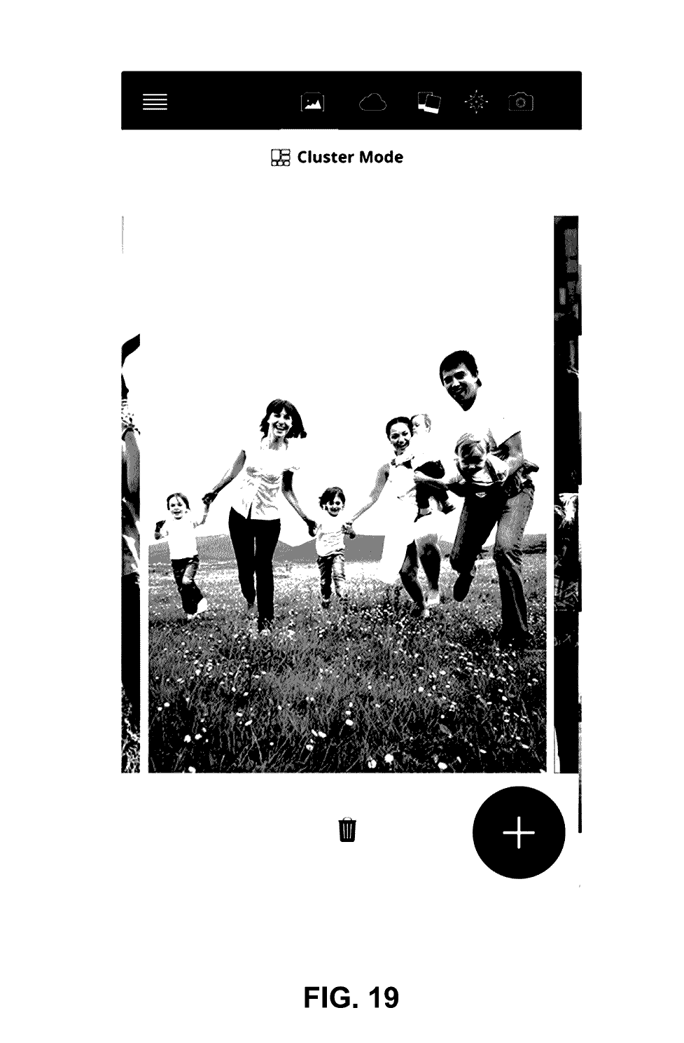

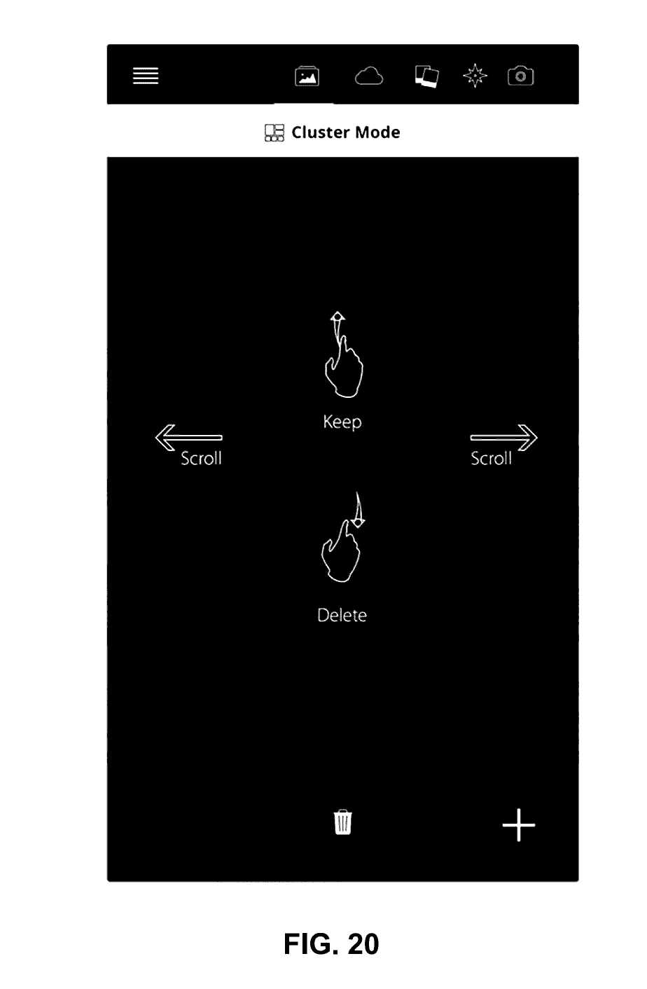

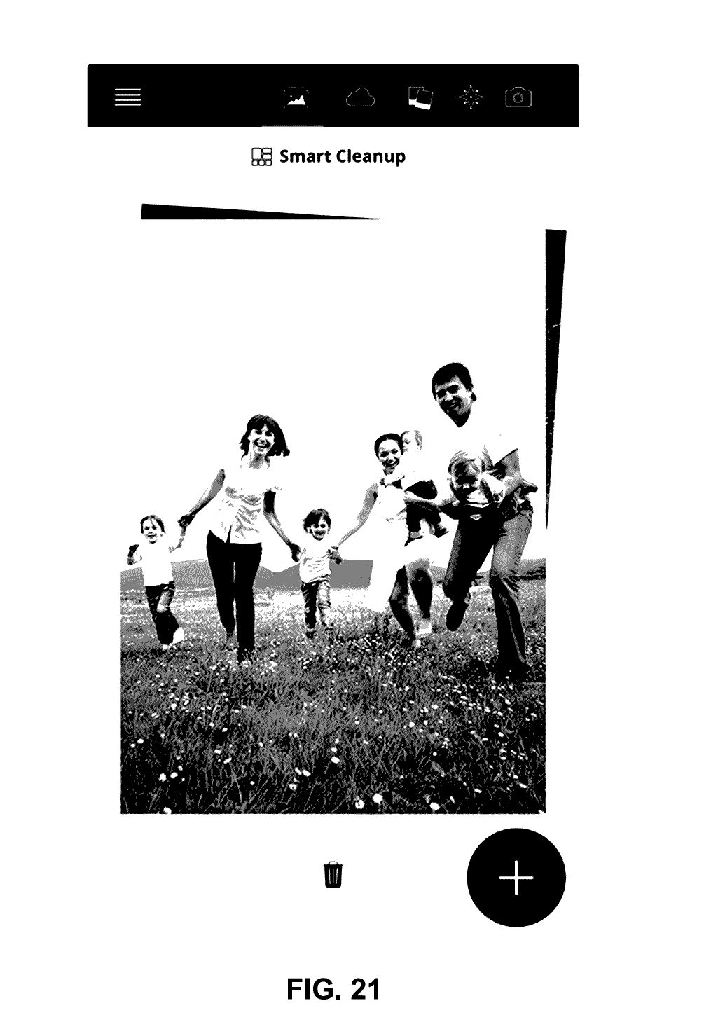

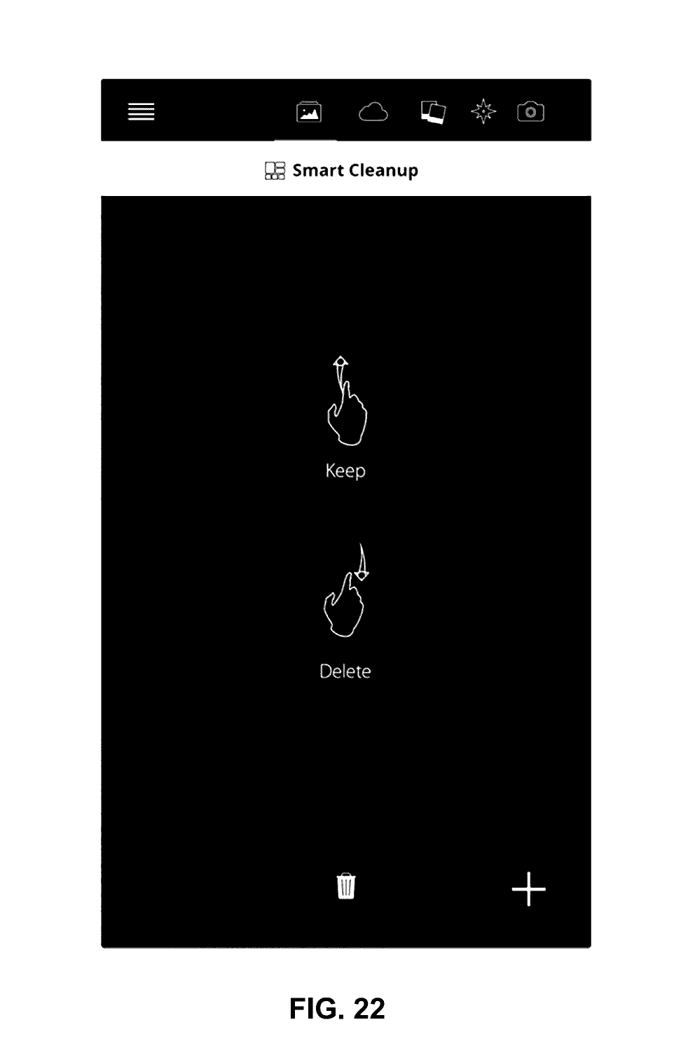

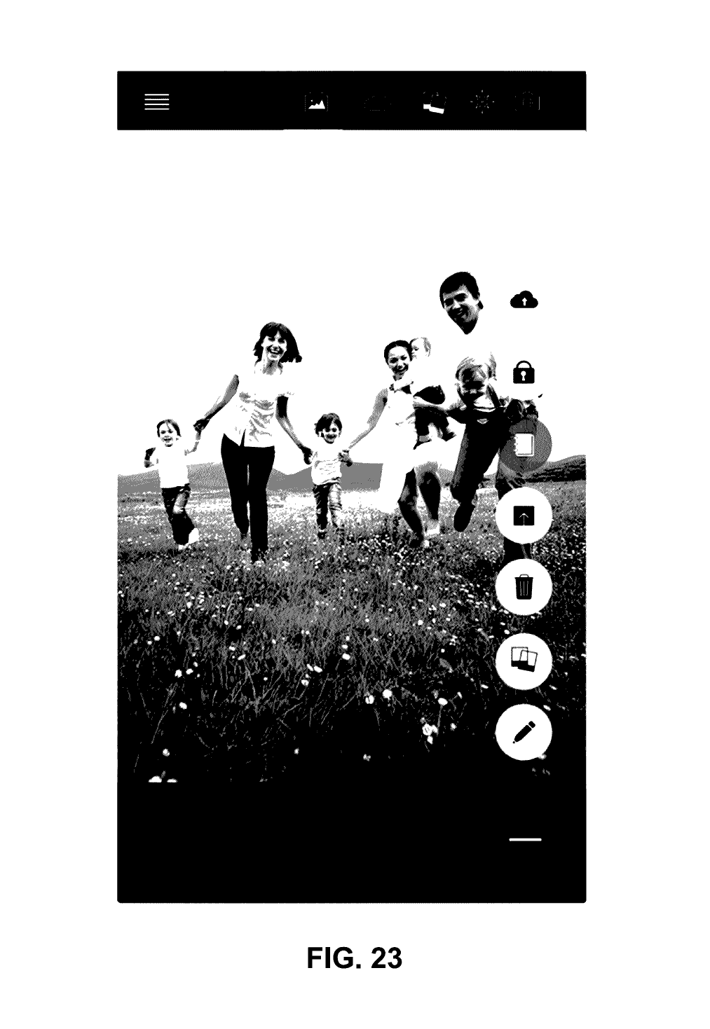

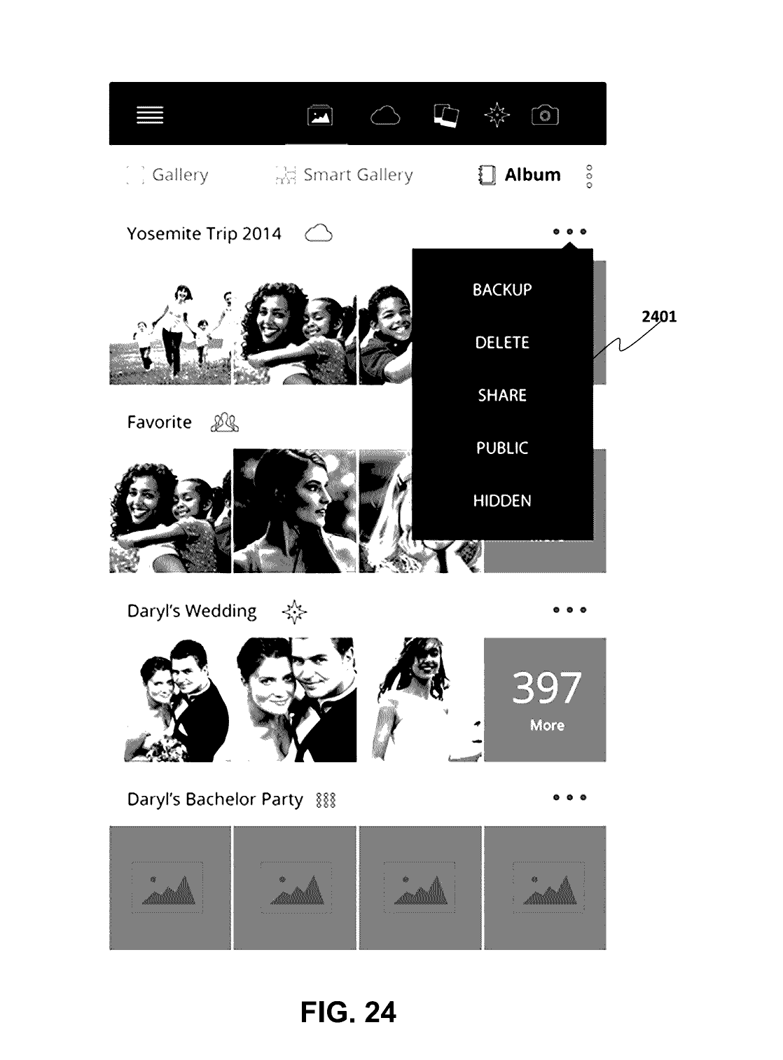

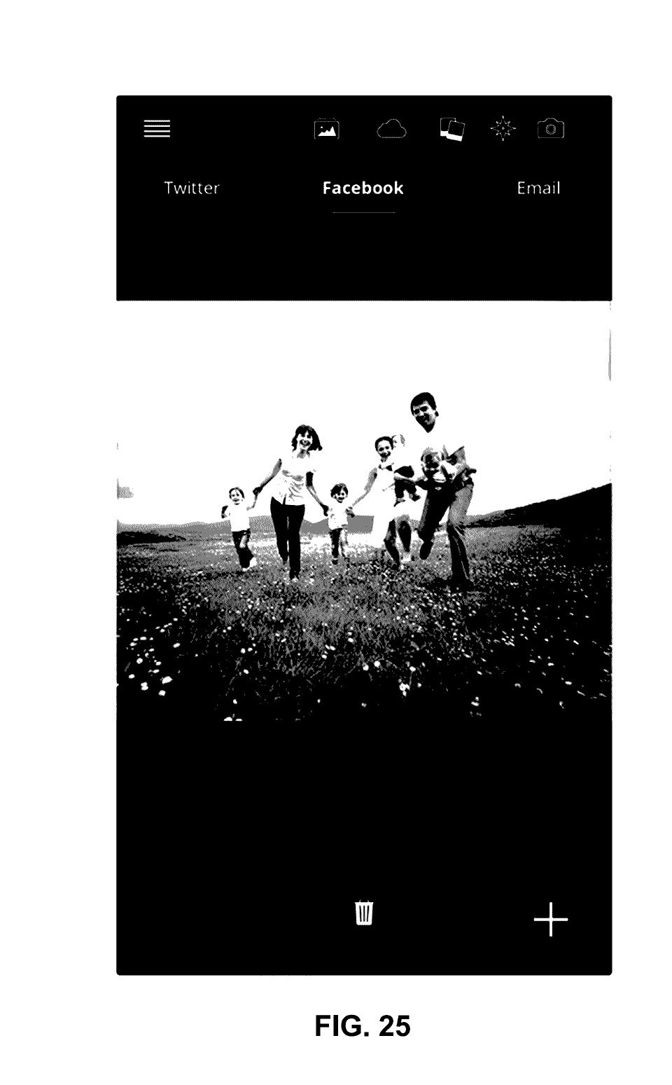

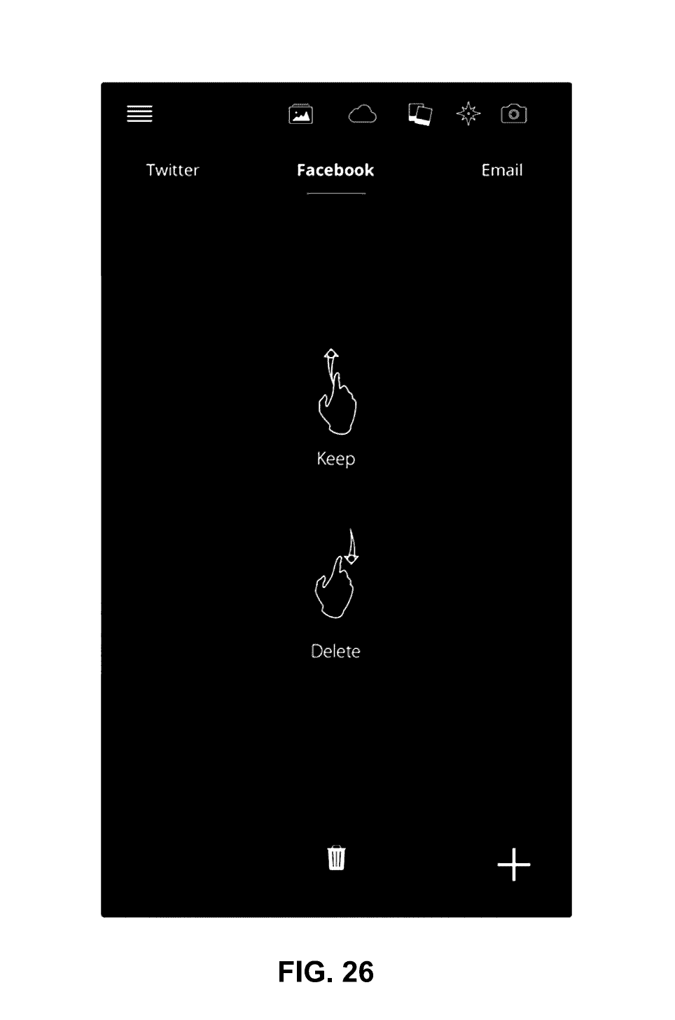

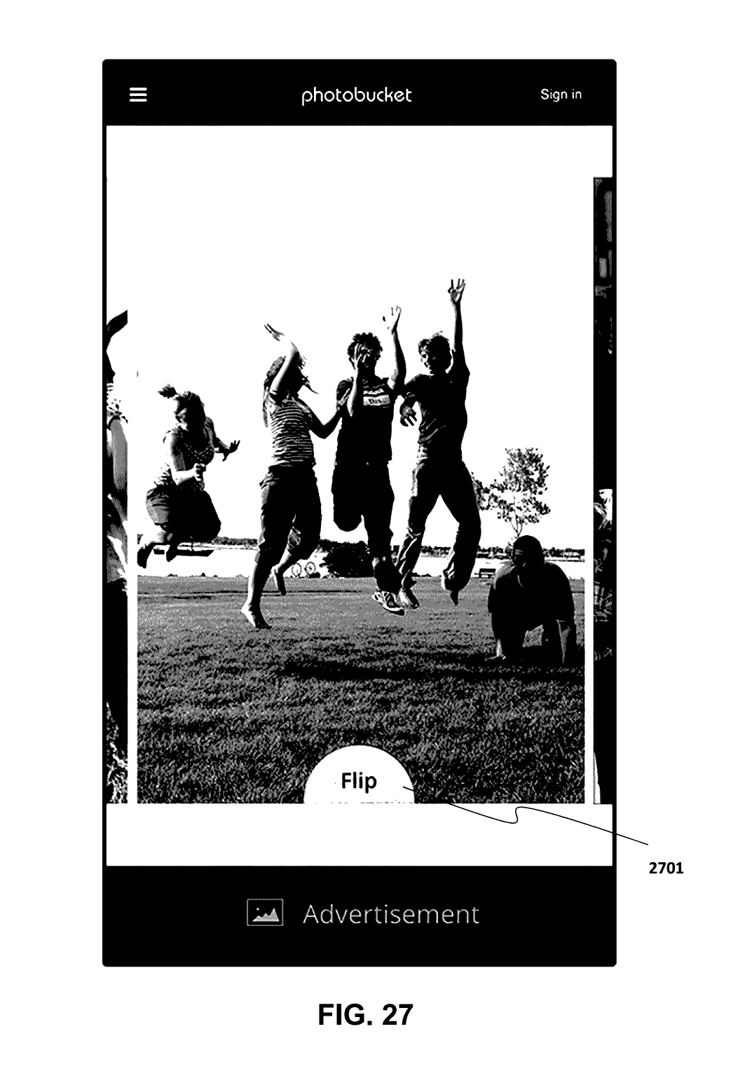

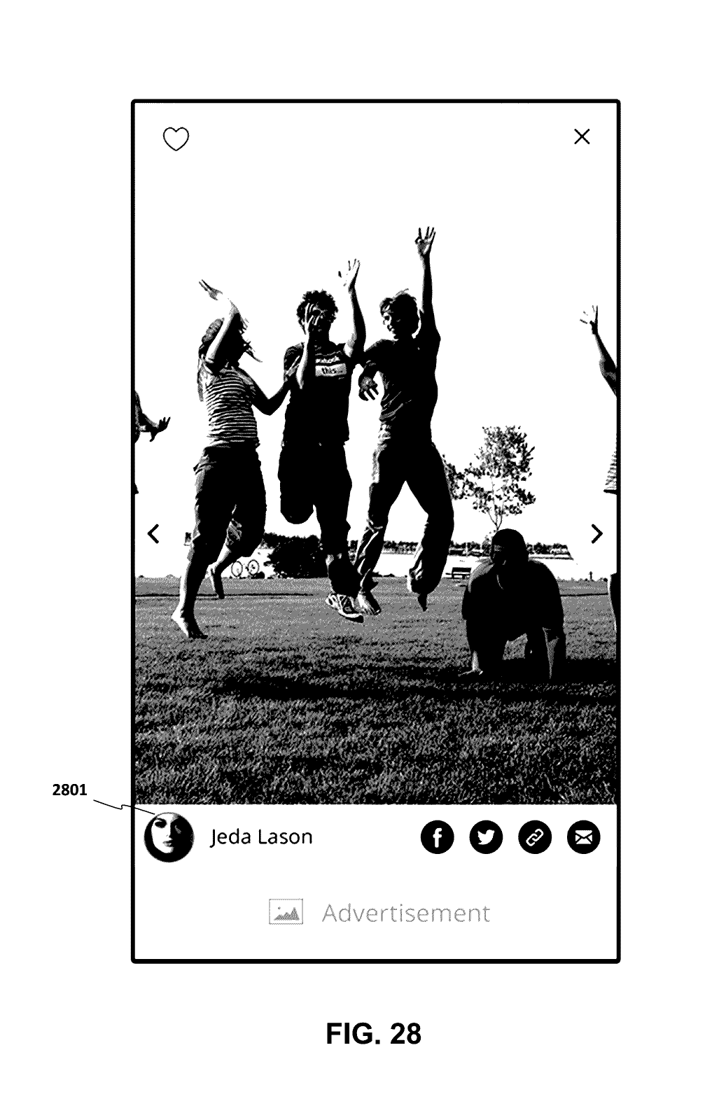

This example shows various implementations of photo presentations and organizations. FIG. 15 shows a photo gallery based on time. FIG. 16 shows a photo gallery based on events. FIG. 17 shows a photo gallery based on an automatic layout. FIG. 18 shows a photo gallery with an editing feature 1801 enabled. FIG. 19 shows a photo gallery in a cluster mode. FIG. 20 shows a photo gallery in a cluster mode with gesture-based editing enabled. FIG. 21 shows a photo gallery with smart cleanup. FIG. 22 shows a photo gallery with smart cleanup and gesture-based editing. FIG. 23 shows a photo with various processing icons enabled. FIG. 24 shows a photo gallery with a menu 2401 of photo processing options. FIG. 25 shows a photo to be shared on a social network media. FIG. 26 shows a photo to be shared on a social network media, with gesture-based editing enabled. FIG. 27 shows a photo with an option 2701 to flip the photo. FIG. 28 shows a photo with social media feed 2801.

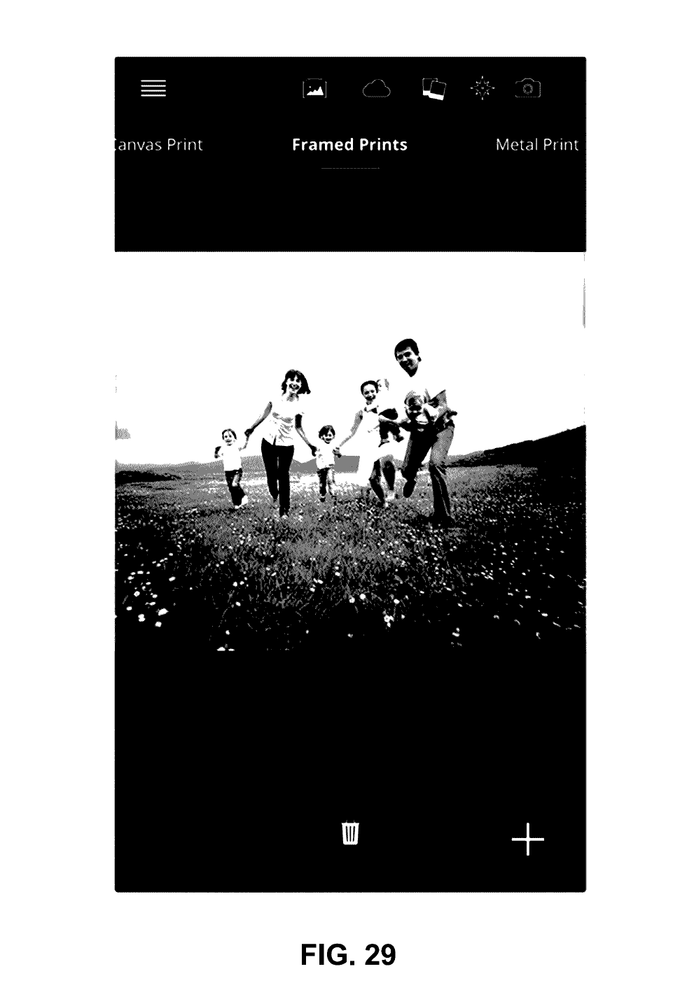

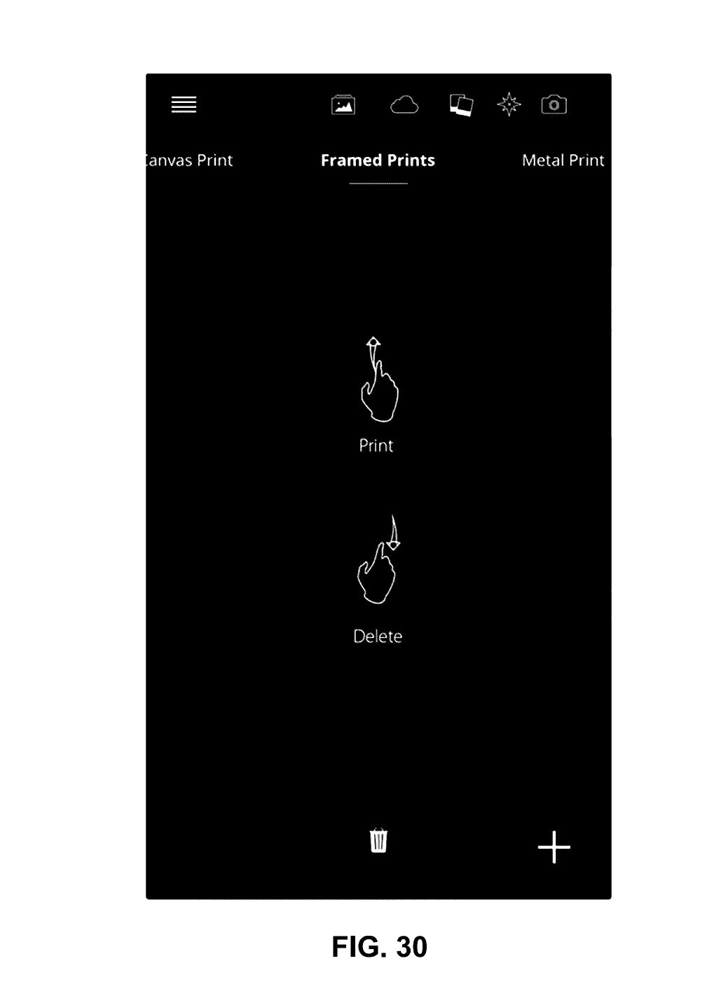

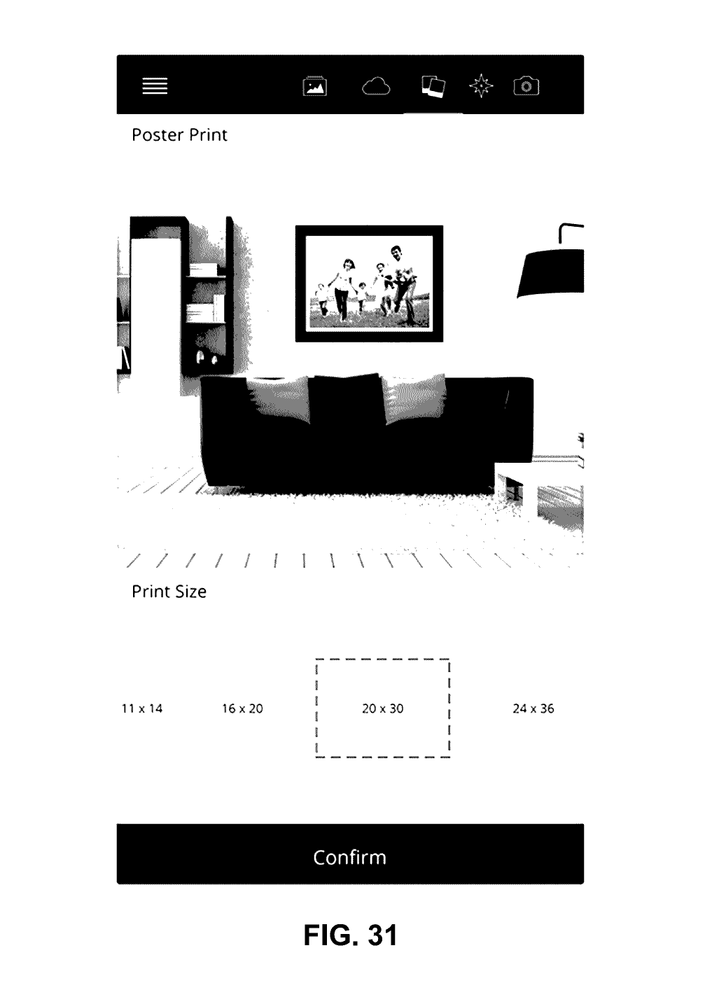

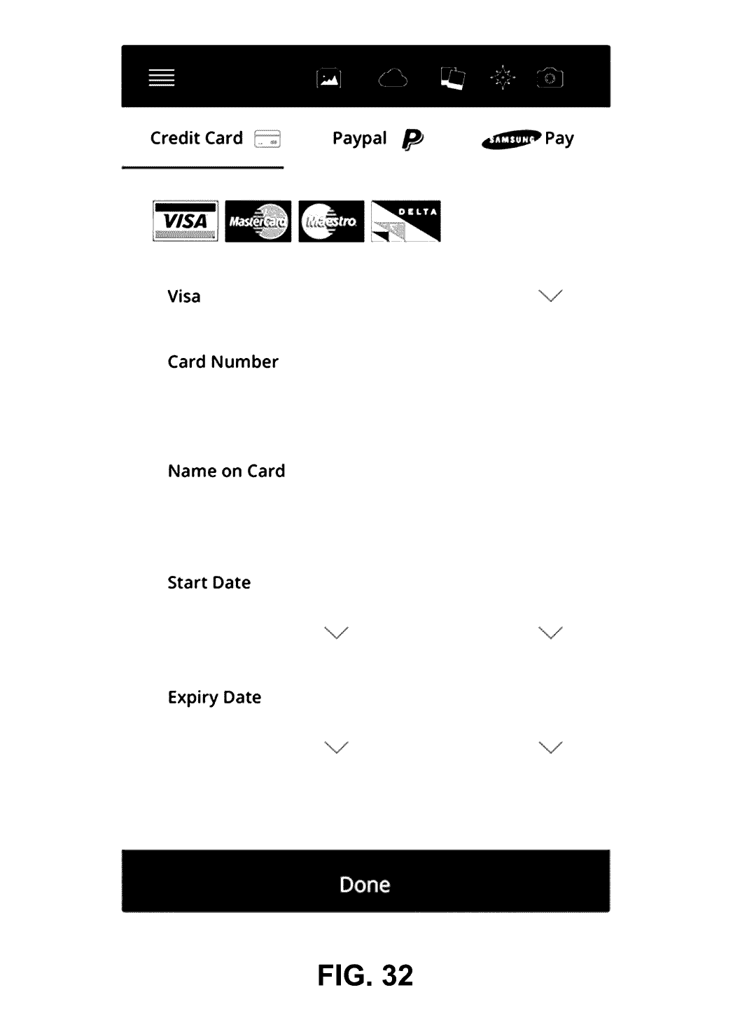

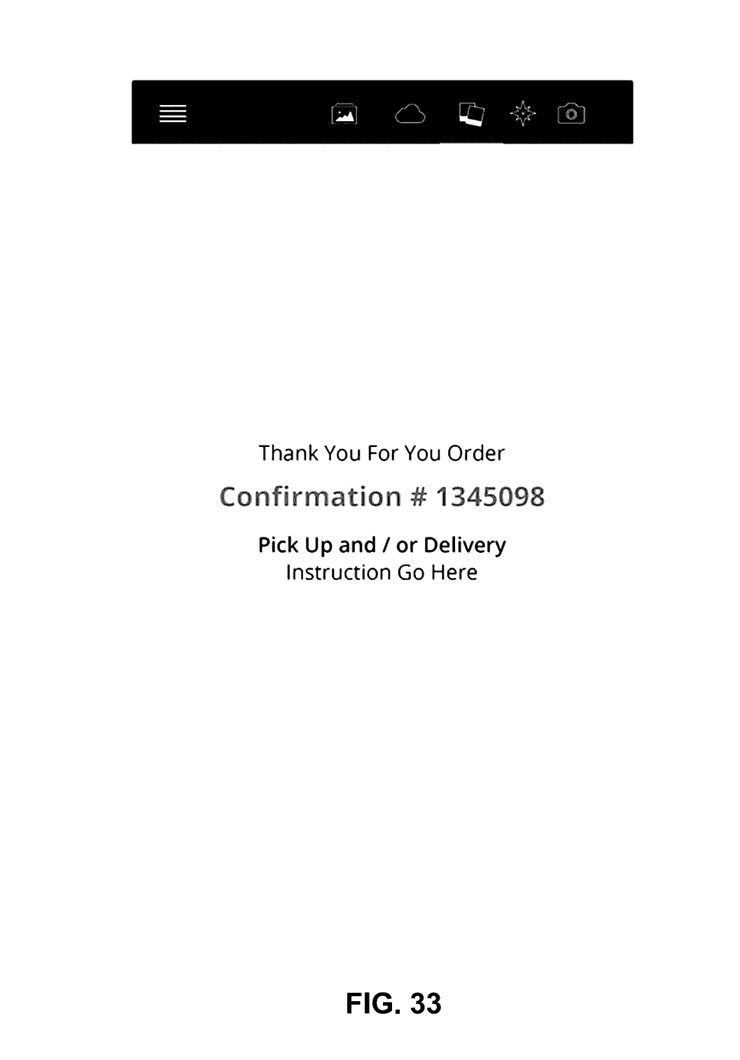

FIG. 29 shows a photo for a framed print. FIG. 30 shows a photo for a framed print with gesture-based editing enabled. FIG. 31 shows a photo for a poster print with size selection. FIG. 32 shows payment processing for photo printing. FIG. 33 shows a confirmation of a photo printing order.

### Example 4

### Photo Deduplication

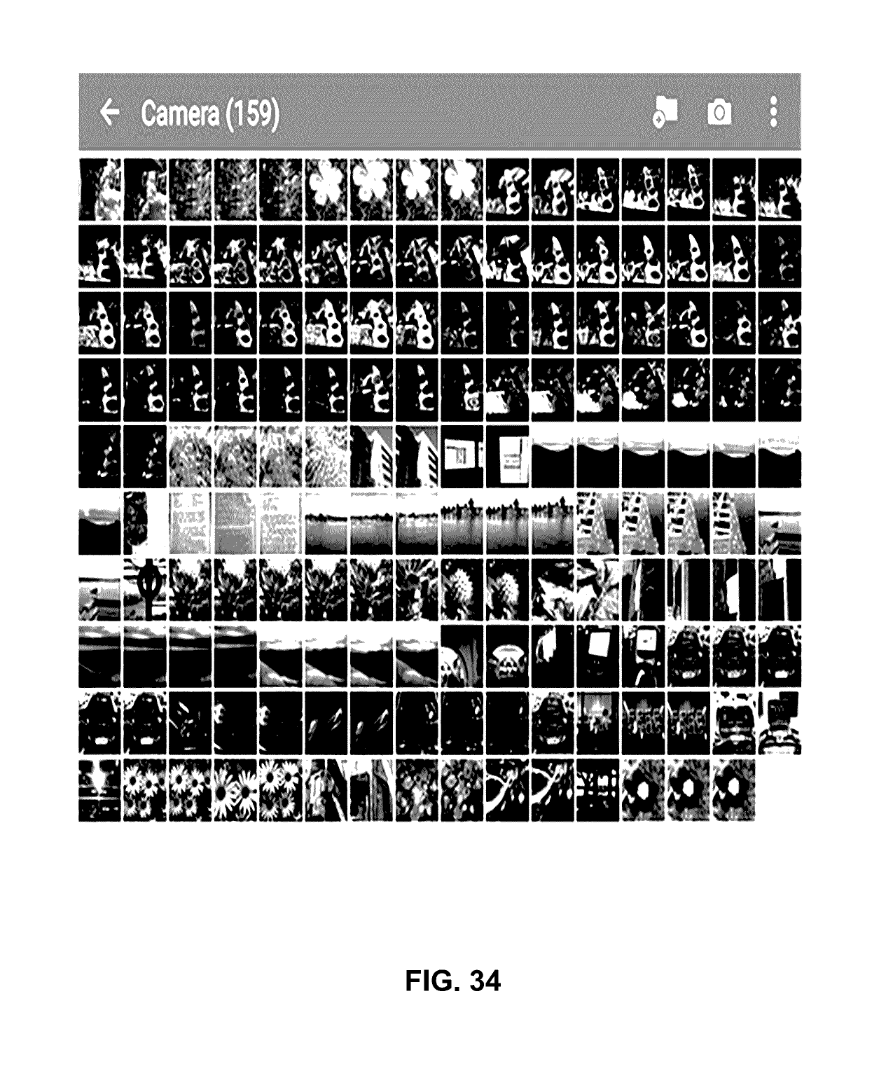

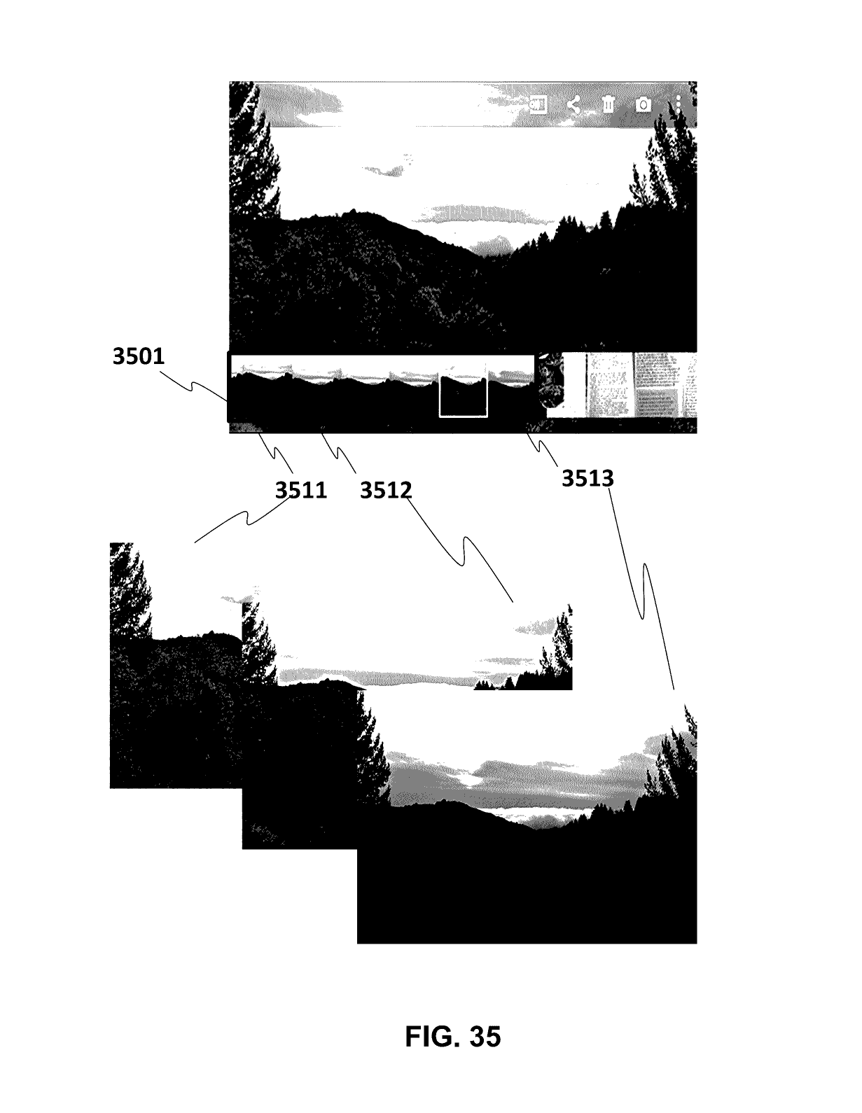

FIG. 34 shows an example of photo gallery where a user shoot multiple pictures to ensure a good one. However, mobile phone galleries are largely unstructured and clutter quickly. After even a few weeks, users have trouble locating important photos. It's an overly-manual effort to find and isolate the best photos. To address the problem, the system is enabled to analyze duplicated photos. Referring FIG. 35, the user swipes through the sequence 3501 of photos in order to find the best one. Alternatively, an intelligent analysis is performed to analyze the sequence 3501 of photos, and identify good quality photos 3511, 3512 and 3513 to decide the best photo representing this scene.

### Example 5

### Computer System

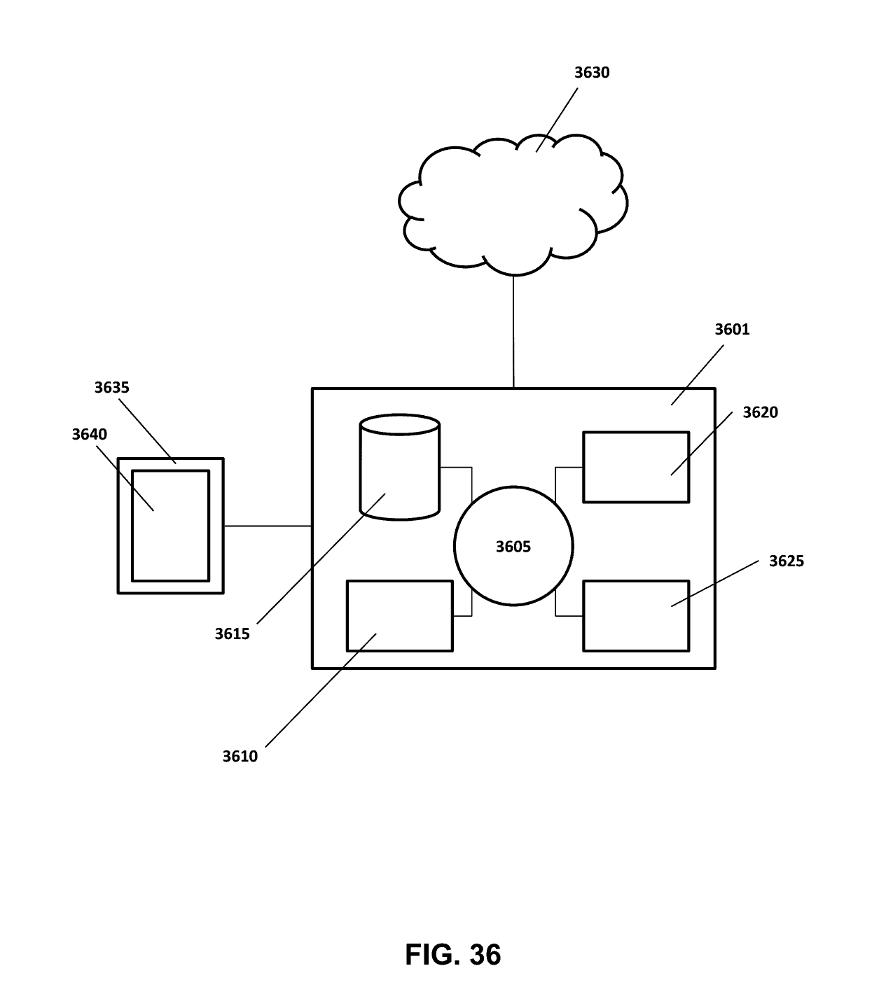

The present disclosure provides computer control systems that are programmed to implement methods of the disclosure. FIG. 36 shows a computer system 3601 that is programmed or otherwise configured to process or organize photos. The computer system 3601 can regulate various aspects of photo processing of the present disclosure. The computer system 3601 can be an electronic device of a user or a computer system that is remotely located with respect to the electronic device. The electronic device can be a mobile electronic device.

The computer system 3601 includes a central processing unit (CPU, also “processor” and “computer processor” herein) 3605, which can be a single core or multi core processor, or a plurality of processors for parallel processing. The computer system 3601 also includes memory or memory location 3610 (e.g., random-access memory, read-only memory, flash memory), electronic storage unit 3615 (e.g., hard disk), communication interface 3620 (e.g., network adapter) for communicating with one or more other systems, and peripheral devices 3625, such as cache, other memory, data storage and/or electronic display adapters. The memory 3610, storage unit 3615, interface 3620 and peripheral devices 3625 are in communication with the CPU 3605 through a communication bus (solid lines), such as a motherboard. The storage unit 3615 can be a data storage unit (or data repository) for storing data. The computer system 3601 can be operatively coupled to a computer network (“network”) 3630 with the aid of the communication interface 3620. The network 3630 can be the Internet, an internet and/or extranet, or an intranet and/or extranet that is in communication with the Internet. The network 3630 in some cases is a telecommunication and/or data network. The network 3630 can include one or more computer servers, which can enable distributed computing, such as cloud computing. The network 3630, in some cases with the aid of the computer system 3601, can implement a peer-to-peer network, which may enable devices coupled to the computer system 3601 to behave as a client or a server.

The CPU 3605 can execute a sequence of machine-readable instructions, which can be embodied in a program or software. The instructions may be stored in a memory location, such as the memory 3610. The instructions can be directed to the CPU 3605, which can subsequently program or otherwise configure the CPU 3605 to implement methods of the present disclosure. Examples of operations performed by the CPU 3605 can include fetch, decode, execute, and writeback.

The CPU 3605 can be part of a circuit, such as an integrated circuit. One or more other components of the system 3601 can be included in the circuit. In some cases, the circuit is an application specific integrated circuit (ASIC).

The storage unit 3615 can store files, such as drivers, libraries and saved programs. The storage unit 3615 can store user data, e.g., user preferences and user programs. The computer system 3601 in some cases can include one or more additional data storage units that are external to the computer system 3601, such as located on a remote server that is in communication with the computer system 3601 through an intranet or the Internet.

The computer system 3601 can communicate with one or more remote computer systems through the network 3630. For instance, the computer system 3601 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 3601 via the network 3630.

Methods as described herein can be implemented by way of machine (e.g., computer processor) executable code stored on an electronic storage location of the computer system 3601, such as, for example, on the memory 3610 or electronic storage unit 3615. The machine executable or machine readable code can be provided in the form of software. During use, the code can be executed by the processor 3605. In some cases, the code can be retrieved from the storage unit 3615 and stored on the memory 3610 for ready access by the processor 3605. In some situations, the electronic storage unit 3615 can be precluded, and machine-executable instructions are stored on memory 3610.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 3601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 3601 can include or be in communication with an electronic display 3635 that comprises a user interface (UI) 3640 for providing, for example, photo editing. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 3605.

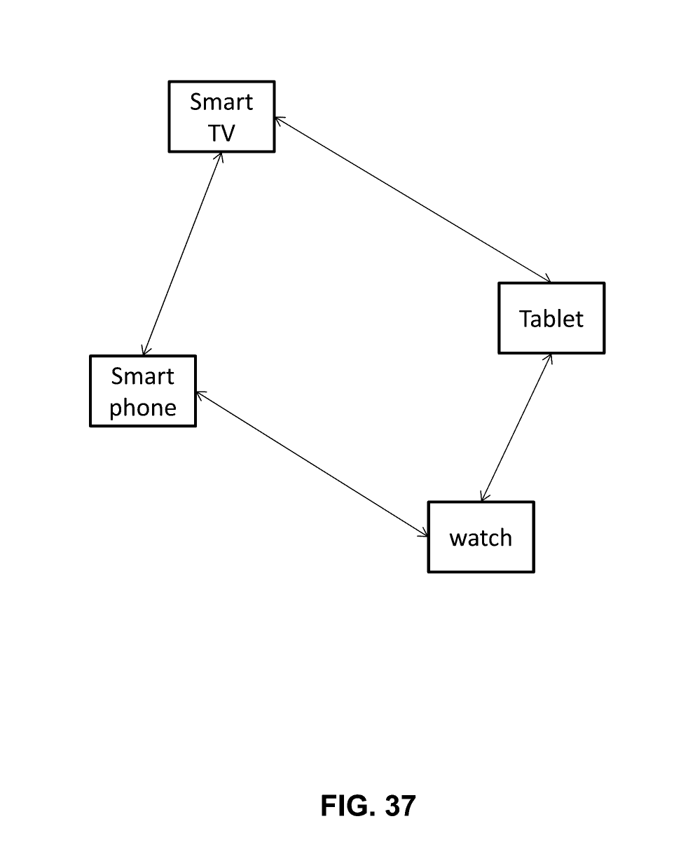

Referring FIG. 37, in some embodiments, a computing device is networked with another device for photo processing, viewing, sharing, and organization. Examples of computing devices include smartphones, tablets, watches, set-top boxes, and TVs.

### Example 6

### Foto Fade

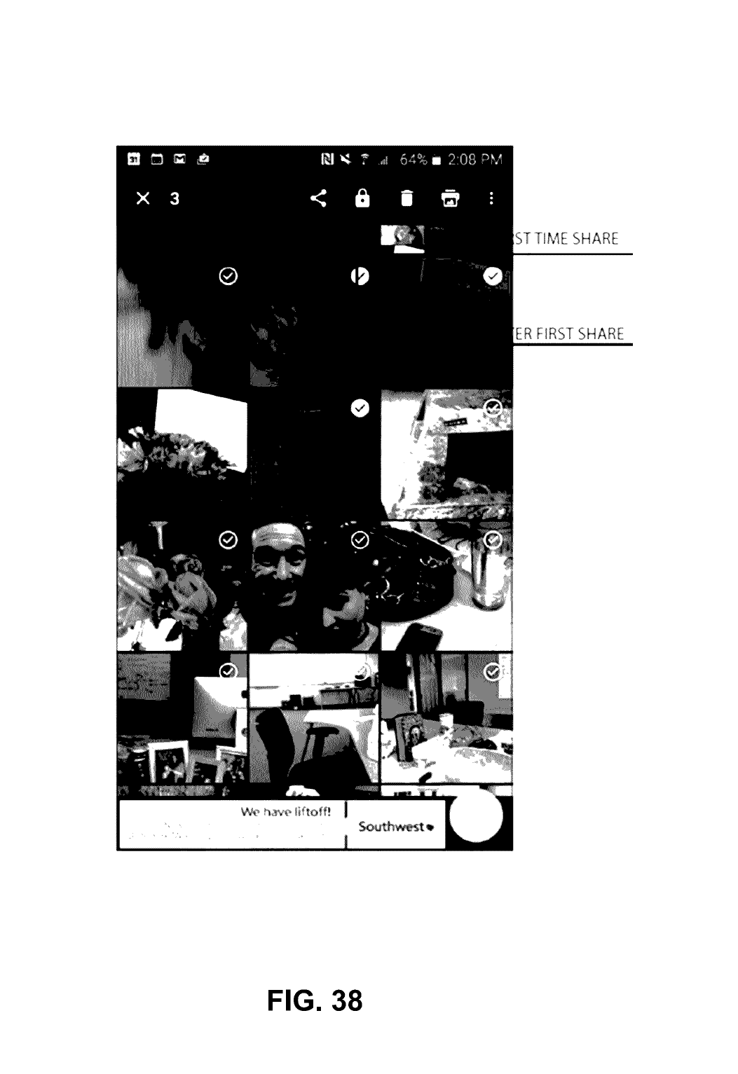

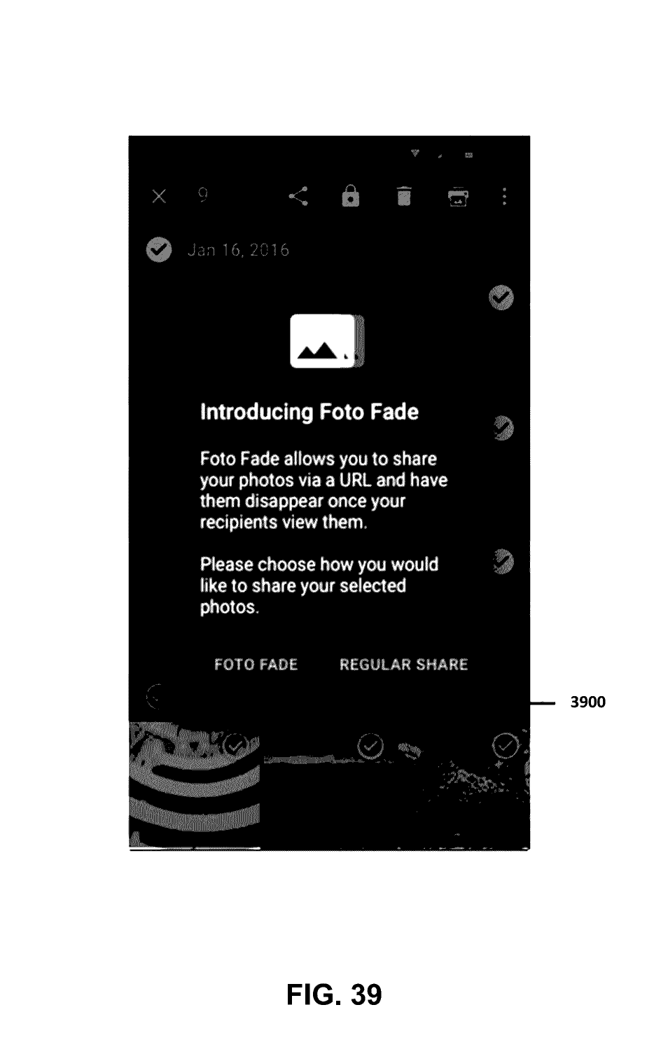

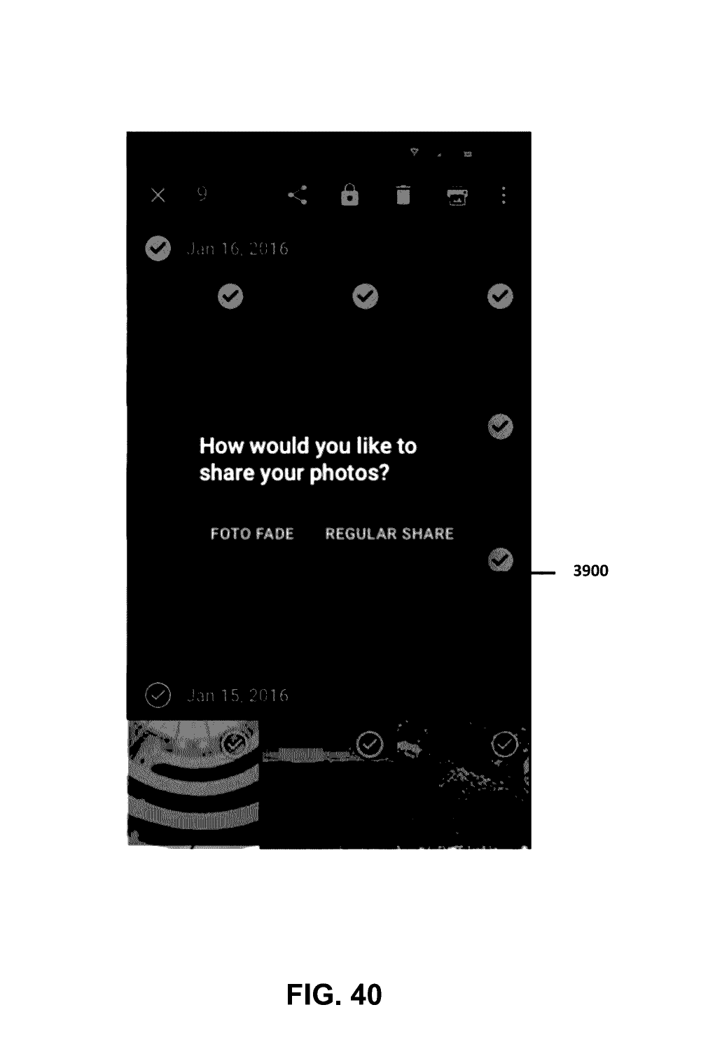

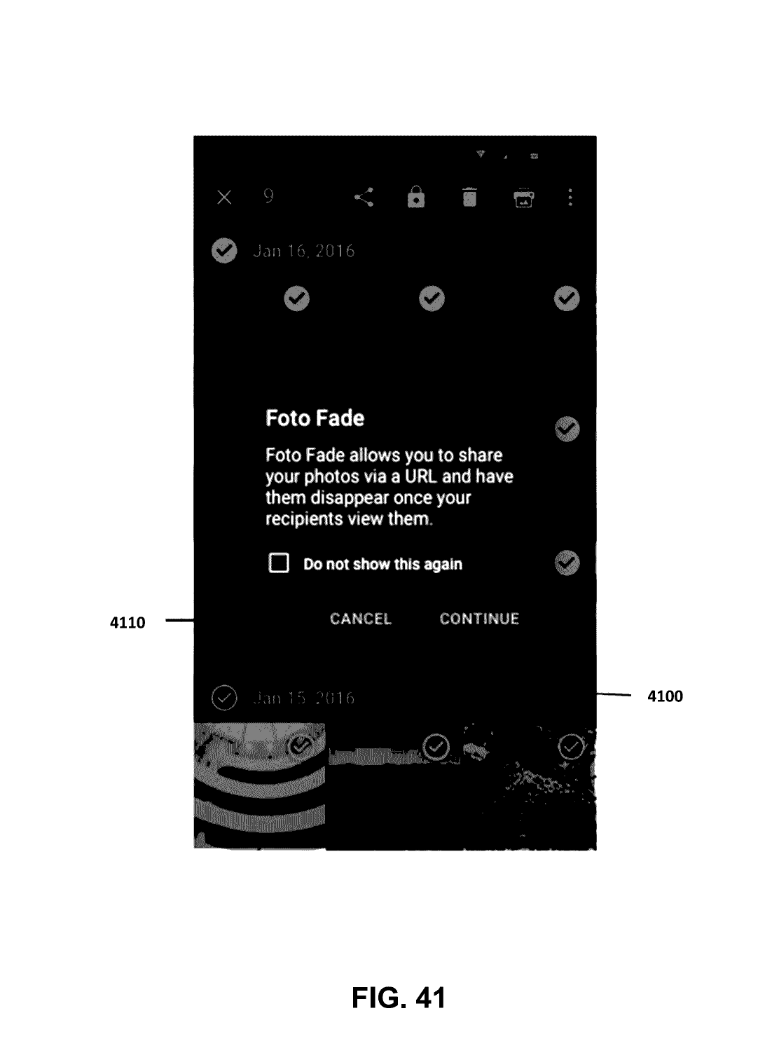

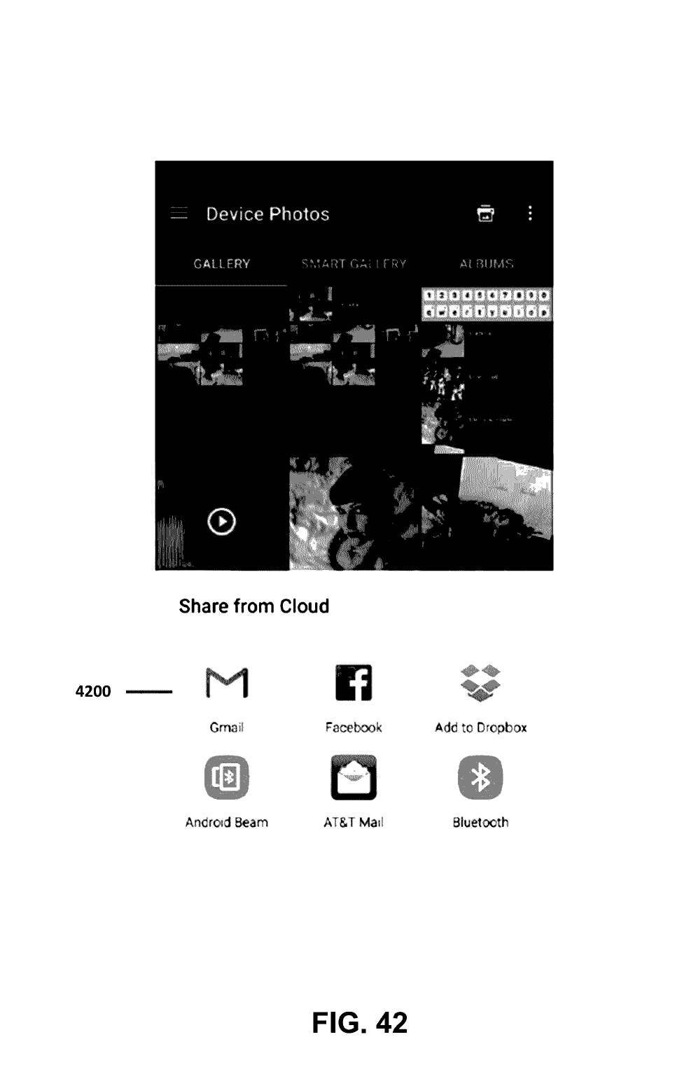

The present disclosure provides a foto fade photo sharing feature. FIG. 38 shows a photo gallery including a photo sharing feature such as a foto fade feature. The information displayed in response to a user accessing the photo sharing feature differs based on whether the user has previously accessed the feature. FIGS. 39-41 show dialogs providing explanatory information to a user and access to a foto fade feature 3900 or more traditional sharing 4100. FIG. 42 shows a photo sharing draw allowing a user to select a sharing mechanism selected from email 4200 (e.g., Gmail, Yahoo mail, Hotmail, AT&T Mail, etc.), social networking (e.g., Facebook, LinkedIn, etc.), file sharing (e.g., Dropbox, etc.), an NFC-based device-to-device file transfer (e.g., Bluetooth, etc.).

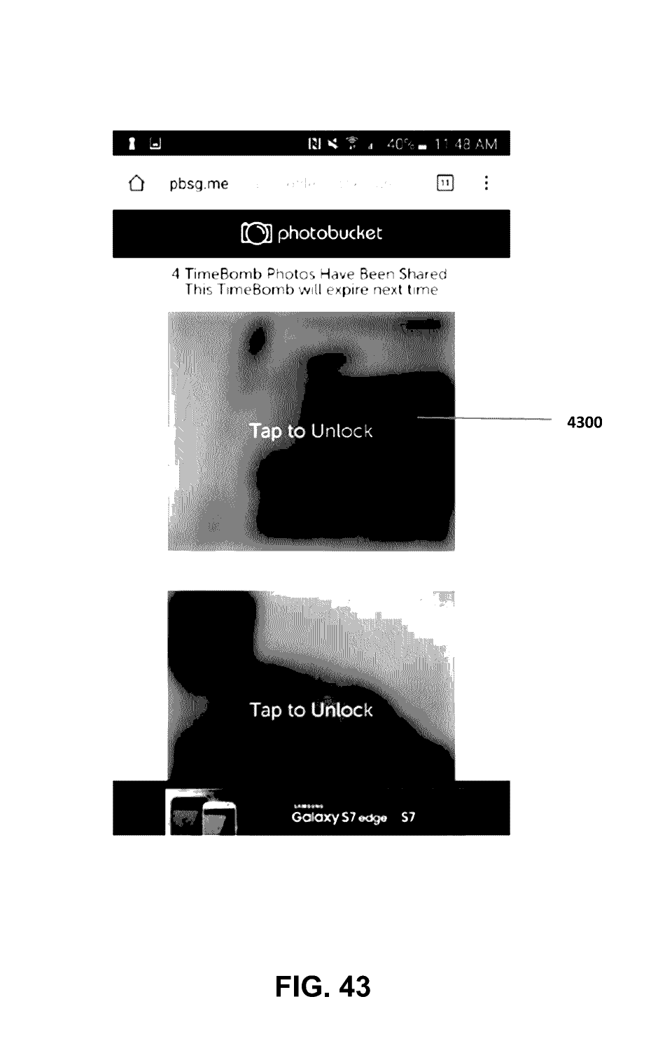

Referring to FIG. 43, a URL is published for shared photos. Upon accessing the URL, a recipient is presented with the shared photos in an obscured form 4300. In some embodiments, the obscured form allows the recipient to perceive that the image is a photo, but does not allow the recipient to discern the subject matter of the photo. Many obscured forms are suitable, including, by way of non-limiting examples, blurred, partially covered, distorted, pixelated, and the like. When the recipient accesses the URL, in some embodiments, the recipient's device is fingerprinted so that subsequent access events can be detected.

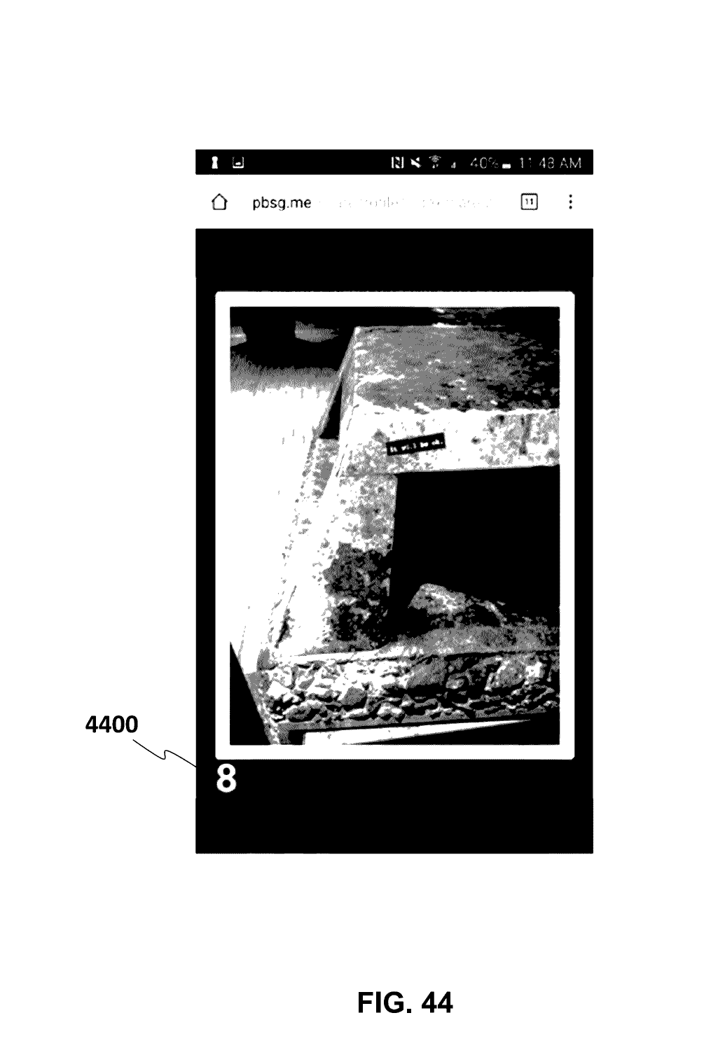

Referring to FIG. 44, upon a recipient interacting with the obscured photo, it is replaced with a clear and viewable version of the photo, which may be enlarged. The viewable version of the photo will only be available during a limited period of time, such as during a countdown period, which is communicated by display of a numeric countdown 4400. Many countdown periods are suitable, including, by way of non-limiting examples, one month, one week, one day, one hour, one minute, and the like, including increments therein. In various embodiments, suitable countdown periods include, 20, 19, 18, 17, 16, 15, 14, 13, 12, 11, 10, 9, 8, 7, 6, 5, 4, 3, 2, minutes, or 1 minute, including increments therein.

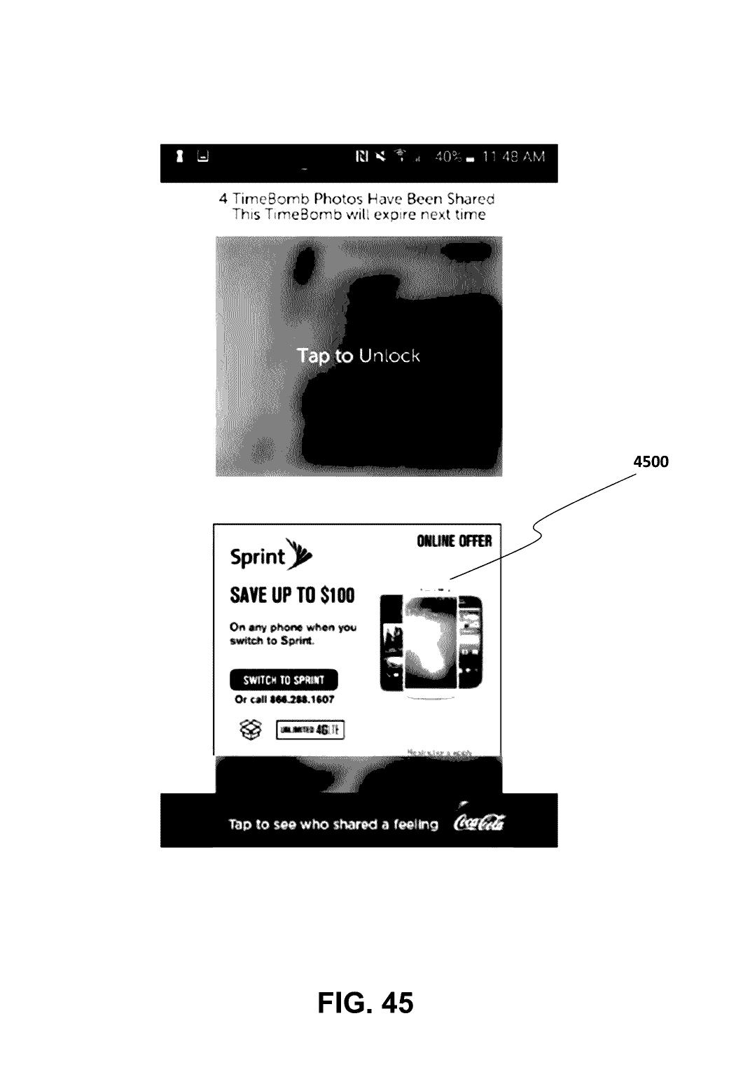

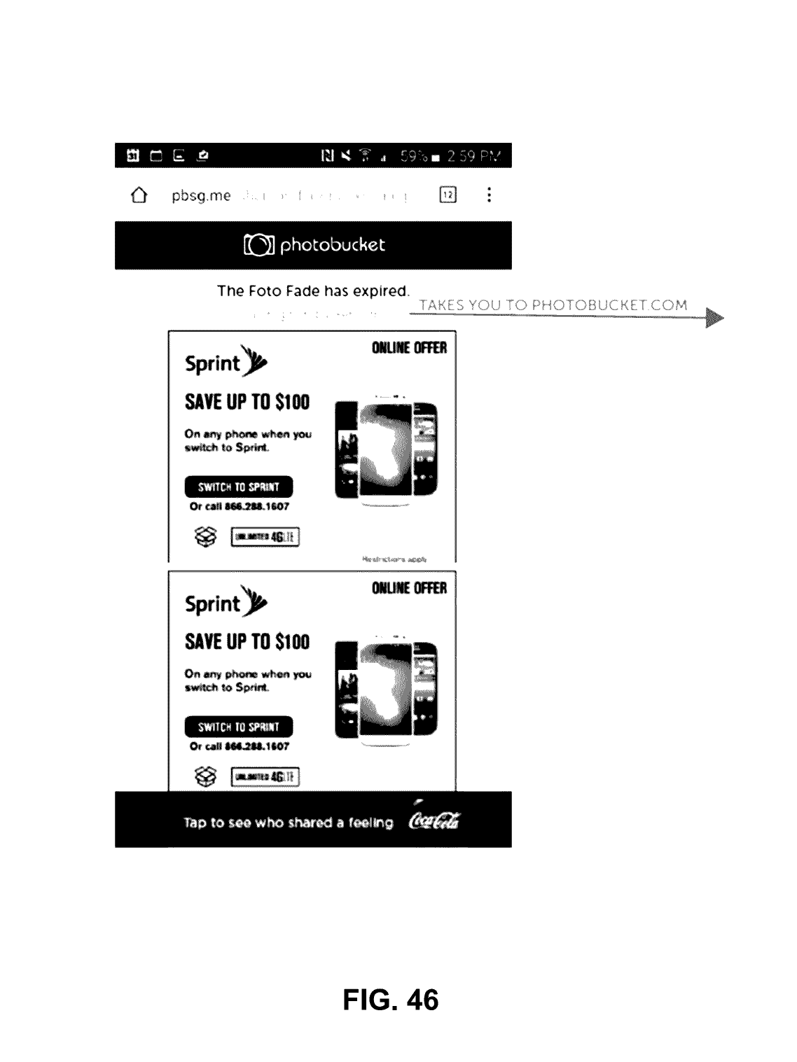

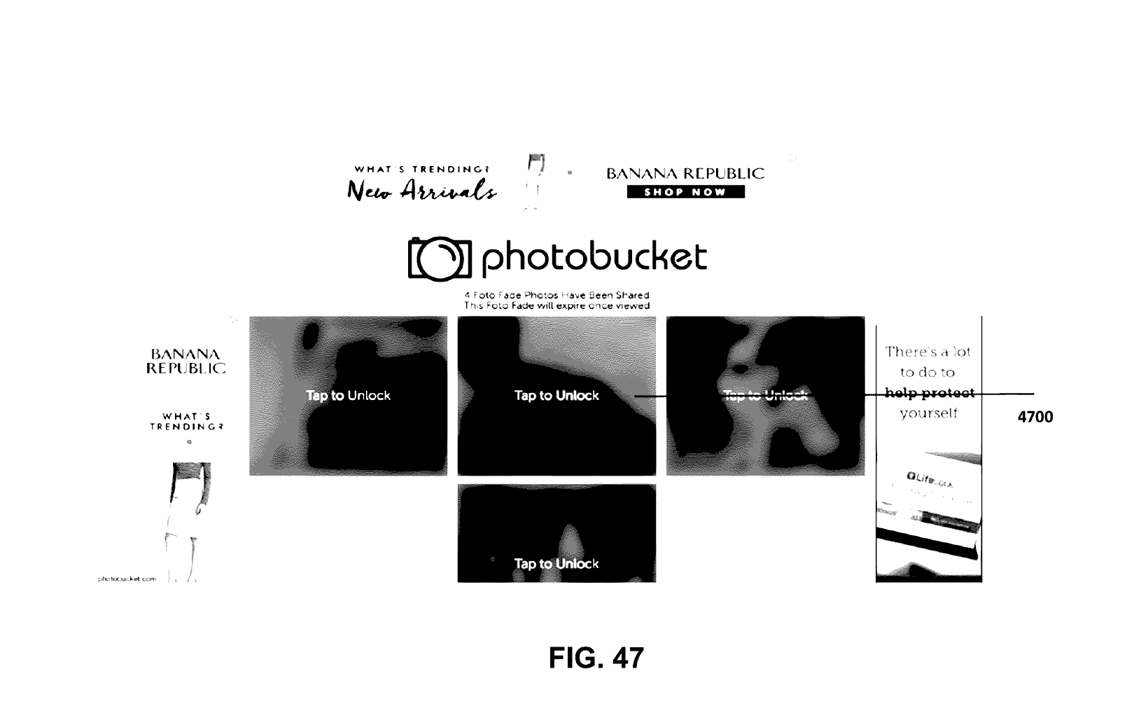

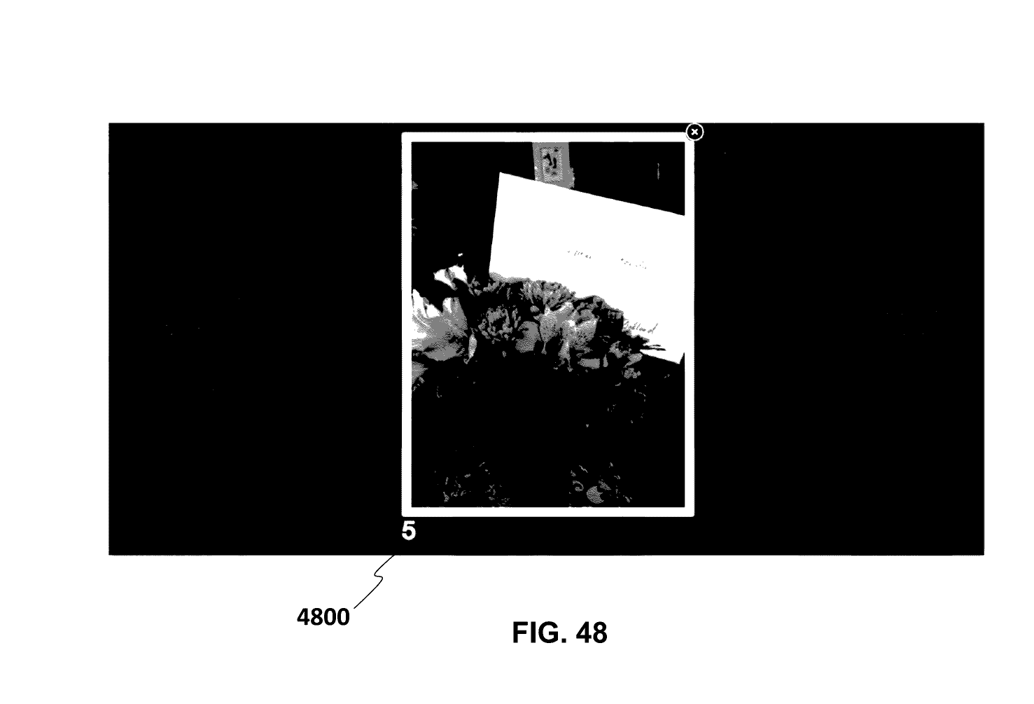

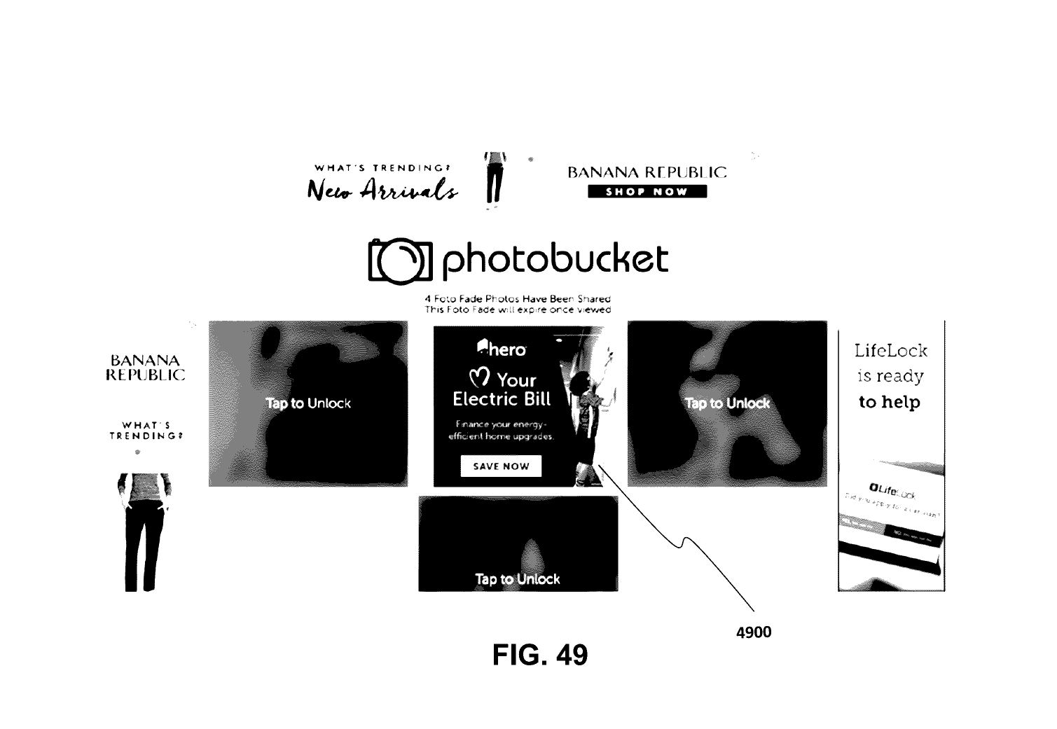

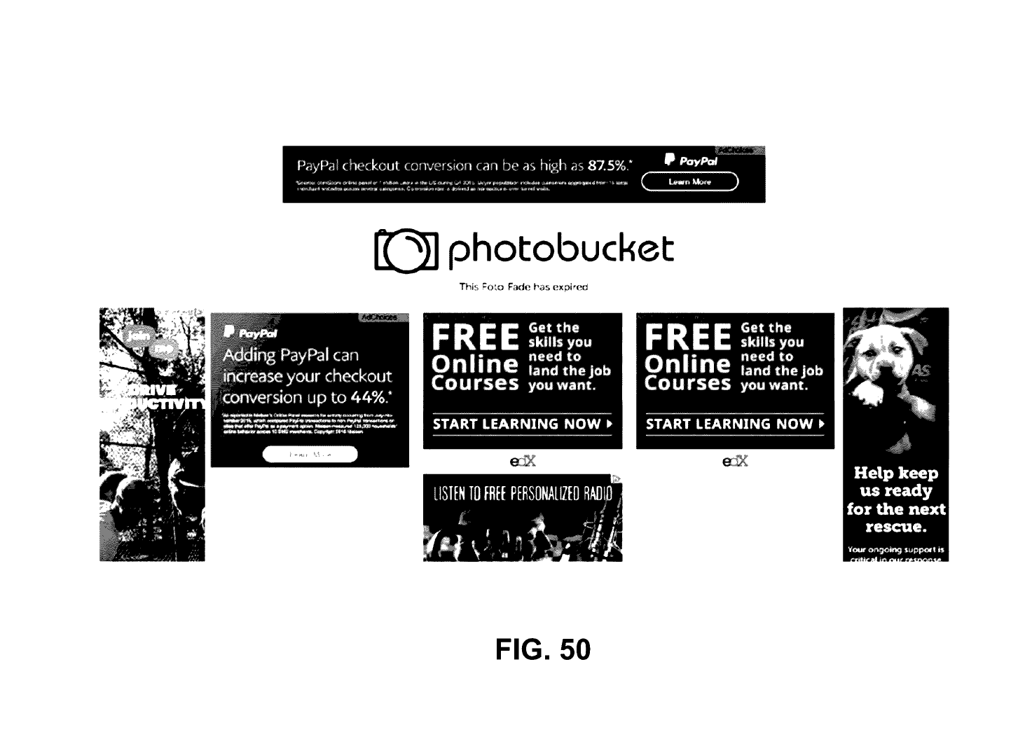

Referring to FIG. 45, upon expiration of a limited viewing period, each photo is replaced with an ad 4500. FIG. 46 shows an interface wherein all the photos have been viewed, the viewing period has expired, and the photos have been replaced with ads. FIGS. 47-50 show a desktop variant of the foto fade feature.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computing system for photo processing and organization, the system comprising:
a) a digital processing device comprising at least one processor, a memory module and an operating system configured to perform executable instructions;
b) a touchscreen; and
c) a computer program including instructions executable by the digital processing device to create an application, the application comprising:
i) a software module receiving a plurality of photos;
ii) a software module presenting the plurality of the photos to a user based on an intelligent analysis on the plurality of the photos;
iii) a software module removing duplicated photos;
iv) a software module grouping the plurality of the photos based on similarity; and
v) a software module processing the plurality of the photos based on a gesture.

2. The system of claim 1, wherein the presenting the plurality of the photos is based on a user defined gallery layout.

3. The system of claim 1, wherein the intelligent analysis comprises (a) a statistical analysis and (b) analyzing a history of viewing, editing and sharing the plurality of the photos.

4. The system of claim 1, wherein the removing the duplicated photos comprises identifying similar or identical photos within a time windows and generating a representative photo from similar or identical photos and deleting the similar or identical photos.

5. The system of claim 4, wherein the representative photo comprises a photo selected from the similar or identical photos or synthesized from the similar or identical photos.

6. The system of claim 1, wherein the processing the plurality of the photos comprises one or more of: flipping one or more photos, deleting one or more photos, cropping one or more photos, filtering one or more photos, transforming one or more photos, and editing one or more photos.

7. The system of claim 1, wherein the application further comprises a software module automatically transferring or sharing one or photos to a second computing device, based on one or more of the following: a time window, a bandwidth, a power level, a media type, a photo content, a location of photo being taken, and allowability of the second computing device.

8. The system of claim 1, wherein the application further comprises a software module (a) identifying an object in a photo and (b) identifying or tracking the object in two or more photos.

9. The system of claim 8, wherein the object is in different views or in different sizes in at least two photos.

10. The system of claim 1, wherein the application further comprises a software module printing a photo by allowing a selection of printout size and transmitting the photo to a computing device of a printing service provider.

11. Non-transitory computer-readable storage media encoded with a computer program including instructions executable by at least one processor to create an application for photo processing and organization, the media comprising:
a) a software module receiving a plurality of photos;
b) a software module presenting the plurality of the photos to a user based on an intelligent analysis on the plurality of the photos;
c) a software module removing duplicated photos;
d) a software module grouping the plurality of the photos based on similarity; and
e) a software module processing the plurality of the photos based on a gesture.

12. The media of claim 11, wherein the presenting the plurality of the photos is based on a user defined gallery layout.

13. The media of claim 11, wherein the intelligent analysis comprises (a) a statistical analysis and (b) analyzing a history of viewing, editing and sharing the plurality of the photos.

14. The media of claim 11, wherein the removing the duplicated photos comprises identifying similar or identical photos within a time windows and generating a representative photo from similar or identical photos and deleting the similar or identical photos.

15. The media of claim 14, wherein the representative photo comprises a photo selected from the similar or identical photos or synthesized from the similar or identical photos.

16. The media of claim 11, wherein the processing the plurality of the photos comprises one or more of: flipping one or more photos, deleting one or more photos, cropping one or more photos, filtering one or more photos, transforming one or more photos, and editing one or more photos.

17. The media of claim 11, wherein the application further comprises a software module automatically transferring or sharing one or photos to a second computing device, based on one or more of the following: a time window, a bandwidth, a power level, a media type, a photo content, a location of photo being taken, and allowability of the second computing device.

18. The media of claim 11, wherein the application further comprises a software module (a) identifying an object in a photo and (b) identifying or tracking the object in two or more photos.

19. The media of claim 18, wherein the object is in different views or in different sizes in at least two photos.

20. The media of claim 11, wherein the application further comprises a software module printing a photo by allowing a selection of printout size and transmitting the photo to a computing device of a printing service provider.

21. A computer-implemented method of photo processing and organization comprising:
a) receiving, by a computer, a plurality of photos;
b) presenting, by the computer, the plurality of the photos to a user based on an intelligent analysis on the plurality of the photos;
c) removing, by the computer, duplicated photos;
d) grouping, by the computer, the plurality of the photos based on similarity; and
e) processing, by the computer, the plurality of the photos based on a gesture made on a touchscreen or multi-touch screen.

22. The method of claim 21, wherein the presenting the plurality of the photos is based on a user defined gallery layout.

23. The method of claim 21, wherein the intelligent analysis comprises (a) a statistical analysis, and (b) analyzing a history of viewing, editing and sharing the plurality of the photos.

24. The method of claim 21, wherein the removing the duplicated photos comprises identifying similar or identical photos within a time windows and generating a representative photo from similar or identical photos and deleting the similar or identical photos.

25. The method of claim 24, wherein the representative photo comprises a photo selected from the similar or identical photos or synthesized from the similar or identical photos.

26. The method of claim 21, wherein the processing the plurality of the photos comprises one or more of: flipping one or more photos, deleting one or more photos, cropping one or more photos, filtering one or more photos, transforming one or more photos, and editing one or more photos.

27. The method of claim 21, wherein the application further comprises a software module automatically transferring or sharing one or photos to a second computing device, based on one or more of the following: a time window, a bandwidth, a power level, a media type, a photo content, a location of photo being taken, and allowability of the second computing device.

28. The method of claim 21, wherein the method further comprises (a) identifying, by the computer, an object in a photo, and (b) identifying or tracking the object in two or more photos.

29. The method of claim 28, wherein the object is in different views or in different sizes in at least two photos.

30. The method of claim 21, wherein the method further comprises printing a photo by allowing a selection of printout size and transmitting the photo to a computing device of a printing service provider.

31. A platform comprising:
a) at least one mobile processor configured to provide a mobile photo sharing application comprising:
i) a software module presenting an interface allowing a user to select one or more photos from a library of photos stored locally to the at least one mobile processor;
ii) a software module uploading one or more selected photos to a server photo sharing application, the photos encrypted during the upload;
iii) a software module presenting an interface allowing the user to select one or more sharing mechanisms;
b) at least one server processor configured to provide the server photo sharing application comprising:
i) a software module publishing a URL via one or more selected sharing mechanisms to one or more recipients, the URL providing access to the uploaded photos;
ii) a software module regulating access to the uploaded photos by presenting the uploaded photos in an obscured form, the obscured form replaced by a clear form upon interaction of a recipient, the clear form available during a countdown period and upon expiration of the countdown period, the photo replaced by an ad.

32. The platform of claim 31, wherein the mobile photo sharing application further comprises a software module presenting an interface allowing a user to select one or more recipients.

33. The platform of claim 31, wherein the sharing mechanisms comprise email, SMS, social media, file sharing, or a combination thereof.

34. The platform of claim 31, wherein the obscured form comprises blurred, covered, distorted, pixelated, or a combination thereof.

35. The platform of claim 31, wherein the countdown period is user-configurable.

36. A computer-implemented method of photo sharing comprising:
a) presenting, by a first computer, an interface allowing a user to select one or more photos from a library of photos stored at the first computer;
b) uploading, by the first computer, one or more selected photos to a server photo sharing application, the photos encrypted during the upload;
c) presenting, by the first computer, an interface allowing the user to select one or more sharing mechanisms;
d) publishing, by a second computer, a URL via one or more selected sharing mechanisms to one or more recipients, the URL providing access to the uploaded photos; and
e) regulating, by the second computer, access to the uploaded photos by presenting the uploaded photos in an obscured form, the obscured form replaced by a clear form upon interaction of a recipient, the clear form available during a countdown period and upon expiration of the countdown period, the photo replaced by an ad.

37. The method of claim 36, further comprising presenting, by the first computer, an interface allowing a user to select one or more recipients.

38. The method of claim 36, wherein the sharing mechanisms comprise email, SMS, social media, file sharing, or a combination thereof.

39. The method of claim 36, wherein the obscured form comprises blurred, covered, distorted, pixelated, or a combination thereof.

40. The method of claim 36, wherein the countdown period is user-configurable.
